(19) United States
(12) Patent Application Publication
(10) Pub. No.: US 2026/0044876 A1
(43) Pub. Date: Feb. 12, 2026

(54) Computer-Automated Optimization System for TV Ad Inventory Management

(71) Applicant: Denali TV, Rowayton, CT (US)

(72) Inventor: Long Ellis, Rowayton, CT (US)

(73) Assignee: Denali TV, Rowayton, CT (US)

(21) Appl. No.: 19/294,372

(22) Filed: Aug. 8, 2025

Related U.S. Application Data
(60) Provisional application No. 63/680,820, filed on Aug. 8, 2024.

(51) Int. Cl. G06Q 30/0242; G06Q 30/0272; H04N 21/2543; H04N 21/262

(52) U.S. Cl. CPC G06Q 30/0244; G06Q 30/0272; H04N 21/25435; H04N 21/26241

(57) ABSTRACT

A computer-implemented method and system optimizes television advertising inventory through a neutral platform that benefits both publishers and advertisers. The method includes receiving input data from a television publisher comprising data representing available TV ad inventory and pricing data associated with the available TV ad inventory. The method further includes receiving input data from an advertiser comprising performance estimates for advertising campaigns, Cost Per Outcome (CPO) goals, campaign requirements, flight dates, and placement parameters. The system optimizes placement of the advertising campaigns within the available TV ad inventory based on the input data from the TV publisher and the input data from the advertiser, using a neutral optimization engine that simultaneously balances objectives of maximizing revenue for the TV publisher and minimizing deviations from the CPO goals of the advertiser. The optimization engine calculates hourly unit rates using CPO goals and performance estimates while maintaining confidentiality of sensitive data from both parties. The system creates a more efficient and equitable marketplace for TV advertising by addressing information asymmetry issues that have persisted in the industry.

### CROSS-REFERENCE TO RELATED APPLICATIONS

This application claims priority to U.S. Prov. Pat. App. No. 63/680,820, entitled, “Computer-Automated Optimization System for TV Ad Inventory Management,” filed on Aug. 8, 2024, which is hereby incorporated by reference herein.

### BACKGROUND

Remnant linear TV inventory refers to advertising spaces on television that have not been sold as of a close approach to the broadcast time. The process of selling remnant inventory is crucial for TV publishers who wish to maximize their revenue from unsold slots, while advertisers look to these remnants as potentially cost-effective options for placing their ads.

Traditionally, the sale of remnant TV inventory is handled through a variety of methods including direct sales by the network's sales team, last-minute deals offered to existing clients, or through secondary markets and exchanges. These sales are often characterized by significant price reductions, making them attractive to advertisers with more flexible campaign requirements or those seeking bargain pricing.

Existing techniques for buying and selling remnant TV inventory have a variety of drawbacks and limitations. For example, traditional methods often lack the capability for real-time optimization based on current market conditions or the specific needs of the advertisers. This results in a less efficient matching of available inventory with advertiser demands, potentially leading to unsold inventory or sold at lower than optimal prices. As another example, the pricing of remnant inventory is often not dynamic. It typically does not reflect the true market value of the ad slots, as it fails to account for factors such as viewer demographics or the strategic value of specific time slots. This can lead to revenue loss for publishers and missed opportunities for advertisers. Furthermore, many existing approaches rely heavily on manual processes involving calls and negotiations between buyers and sellers. This is not only time-consuming but also introduces a delay in transaction times, reducing the ability to capitalize on last-minute opportunities effectively.

These limitations highlight the need for an improved approach to managing and selling remnant linear TV inventory to improve the process from the perspective of both buyer and seller.

### SUMMARY

Embodiments of the present invention provide a computer-implemented system and method for optimizing television advertising inventory that addresses the limitations of traditional TV ad placement approaches. The system operates as a neutral platform that simultaneously serves the interests of both TV publishers and advertisers, using optimization algorithms to maximize revenue for publishers while achieving cost-effective ad placements for advertisers. Unlike conventional supply-side platforms or demand-side platforms that favor one party over another, embodiments of the system maintain impartiality by keeping sensitive data confidential while leveraging information from both sides to optimize outcomes.

Embodiments of the present invention may: (1) receive detailed inventory and pricing information from TV publishers through a publisher interface, and (2) receive campaign requirements, performance estimates, and Cost Per Outcome goals from advertisers through an advertiser interface. An optimization engine processes this information to calculate optimal ad placements using techniques such as hourly unit rate calculations based on CPO goals and performance estimates. The system may support any of a variety of optimization methods, such as waterfalling approaches that prioritize highest-paying campaigns, yield maximization strategies that adjust price floors dynamically, and hybrid approaches that combine both techniques. Embodiments of the present invention may incorporate artificial intelligence capabilities to analyze historical campaign data, generate predictive insights, and continuously improve optimization performance over time.

In some embodiments, a computer-implemented method for optimizing television advertising inventory may include receiving input data from a TV publisher, where the input data includes data representing available TV ad inventory and pricing data associated with the available TV ad inventory. The method may also include receiving input data from an advertiser, where the input data includes performance estimates for advertising campaigns, Cost Per Outcome goals, campaign requirements, flight dates, and placement parameters. The method may further include optimizing placement of the advertising campaigns within the available TV ad inventory based on the input data from the TV publisher and the input data from the advertiser, using a neutral optimization engine that simultaneously balances objectives of maximizing revenue for the TV publisher and minimizing deviations from the CPO goals of the advertiser.

Other features and advantages of various aspects and embodiments of the present invention will become apparent from the following description and from the claims.

### BRIEF DESCRIPTION OF THE DRAWINGS

FIG. 1 is a dataflow diagram of a system for optimizing TV ad placement according to one embodiment of the present invention.

FIG. 2 is a flowchart of a method performed by the system according to one embodiment of the present invention.

### DETAILED DESCRIPTION

Embodiments of the present invention are directed to computer-implemented systems and methods that are designed to optimize the buying and selling of linear TV inventory, such as remnant linear TV inventory. Embodiments of the present invention use a neutral, data-driven approach that significantly enhances the efficiency and effectiveness of TV advertising space transactions. Unlike traditional supply-side platforms (SSPs) or demand-side platforms (DSPs), which typically favor either the seller or the buyer, embodiments of the present invention operate impartially, providing equitable benefits to both TV publishers and performance-based advertisers.

Embodiments of the present invention leverage artificial intelligence (AI) algorithms to dynamically optimize ad placements based on a multitude of factors including, but not limited to, cost per outcome (CPO) goals, performance estimates, and specific campaign requirements. This optimization not only maximizes revenue for TV publishers by efficiently selling high-value inventory but also ensures that advertisers achieve their campaign objectives with optimal cost-effectiveness.

The platform is uniquely designed to handle the complexities of TV advertising by allowing for real-time adjustments and providing a high degree of transparency and control to both publishers and advertisers. Through its intuitive user interfaces, embodiments of the present invention facilitate the seamless input and modification of campaign data and inventory specifications, ensuring that all transactions adhere to the specified constraints and performance targets.

Furthermore, embodiments of the present invention include a data analytics module capable of identifying trends and generating actionable insights, which can be used to further refine and enhance the advertising strategies of its users. This capability not only improves the immediate transactional outcomes but also contributes to the long-term success of both publishers and advertisers by continuously adapting to changing market conditions and consumer behaviors.

The use of software interfaces, such as the publisher interface 106 and advertiser interface 118, for exchanging campaign requirements and traffic instructions represents a significant technical improvement over traditional methods that rely on PDF documents and fax transmissions. Traditional PDF and fax-based workflows may suffer from several technical limitations including manual data entry requirements that introduce human error, lack of real-time data validation capabilities, inability to automatically integrate with existing campaign management systems, and delays inherent in document-based communication processes. In contrast, the software interfaces disclosed herein may provide real-time data processing capabilities that enable immediate validation of input parameters, automated error checking that identifies inconsistencies or missing information before processing, seamless integration with existing advertising technology stacks through API connections, and elimination of manual transcription steps that traditionally introduce data accuracy issues. The software interfaces may also support dynamic data formatting that automatically converts input data into standardized formats suitable for optimization processing, real-time synchronization between publisher and advertiser systems that ensures all parties have access to current campaign status, and automated workflow triggers that initiate optimization processes immediately upon receipt of complete input data sets. These technical improvements may result in faster campaign deployment times, reduced operational overhead, improved data accuracy, and enhanced scalability compared to document-based communication methods.

In summary, embodiments of the present invention represent a transformative advancement in the field of television advertising, providing a powerful tool that aligns the interests of TV publishers and advertisers, thereby creating a more efficient, effective, and equitable marketplace for TV ad inventory.

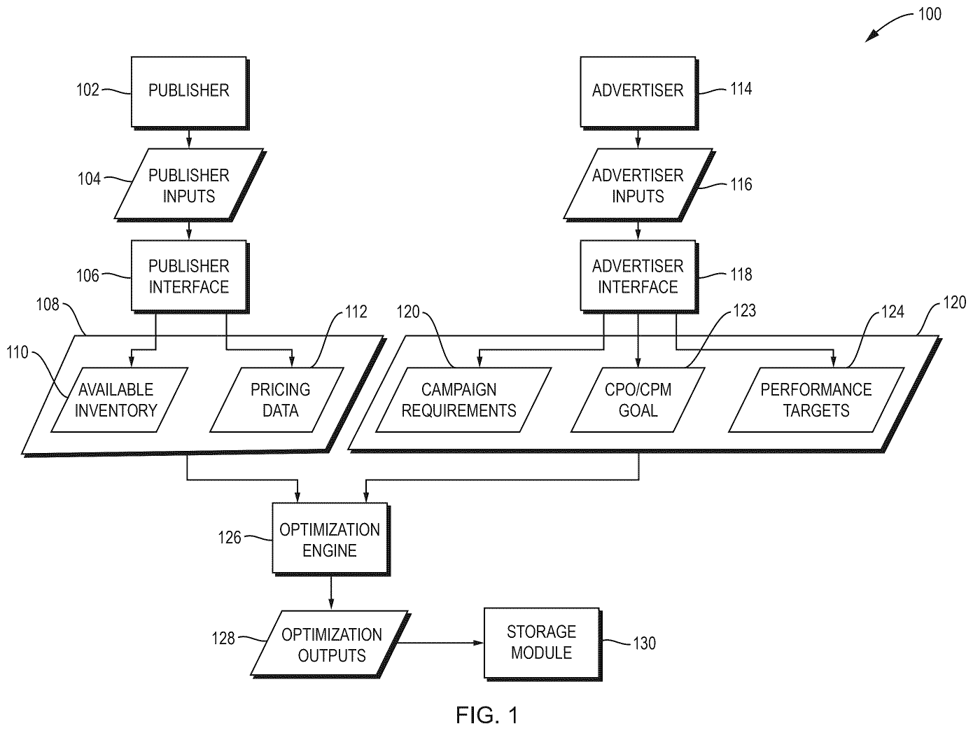

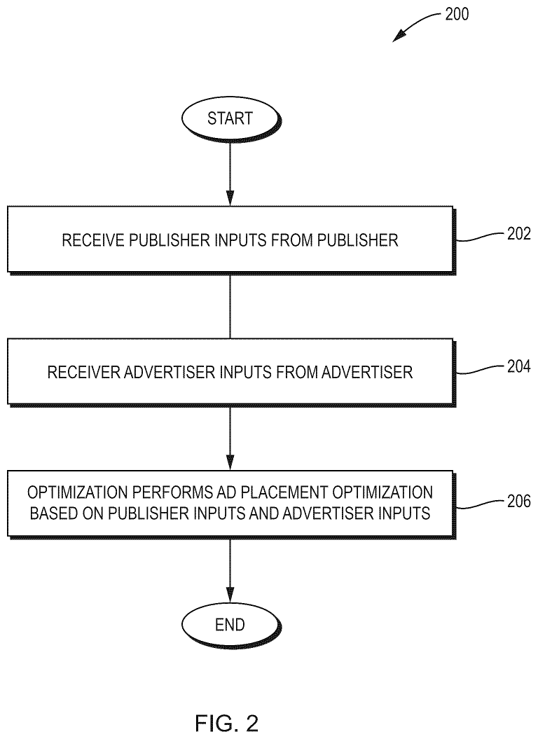

Referring to FIG. 1, a dataflow diagram is shown of a system 100 for optimizing TV ad placement according to one embodiment of the present invention. Referring to FIG. 2, a flowchart is shown of a method 200 performed by the system 100 according to one embodiment of the present invention. Although the description herein may refer to remnant TV inventory, and embodiments of the present invention may be used in connection with remnant TV inventory, embodiments of the present invention are not limited to use in connection with remnant TV inventory.

The system 100 includes a TV publisher 102. The TV publisher 102 refers to any entity that controls or distributes television content with available advertising space. This may include, for example, traditional broadcast networks, cable television channels, satellite TV providers, or even platforms involved in streaming or connected TV services. Although certain embodiments of the present invention optimize placement of linear TV inventory, other embodiments of the present invention optimize placement of connected TV inventory. As this implies, the TV publisher 102 may be a publisher of connected TV inventory. In some cases, the TV publisher 102 may be a publisher of other content, such as terrestrial radio, as embodiments of the present invention may be applied to optimize advertising inventory for terrestrial radio broadcasts in addition to or instead of television content.

TV publishers in general, the TV publisher 102 in particular, may take any of a variety of forms, each with its unique characteristics and inventory management needs, such as broadcast networks, cable and satellite providers, streaming services, and local TV stations.

The TV publisher 102 is the source of the inventory being optimized by the system 100 and method 200. By doing so, the system 100 and method 200 may help the TV publisher 102 to maximize its revenue by efficiently selling inventory (e.g., remnant inventory) at the best possible rates, considering both market demand and the specific characteristics of the inventory.

Although only one TV publisher 102 is shown in FIG. 1 for ease of illustration and explanation, embodiments of the present invention may work in connection with one or a plurality of TV publishers. As a result, any description herein of functions performed by or otherwise in connection with the TV publisher 102 should be understood to be capable of being performed in connection with a plurality of TV publishers.

The system 100 also includes a publisher interface 106, which interfaces with the TV publisher 102. The TV publisher 102 may provide any of a variety of publisher inputs 104 to the publisher interface 106 (FIG. 2, operation 202). The publisher interface 106 may serve as a link between the TV publisher 102 and the system 100. The purpose of the publisher interface 106 may be to facilitate the seamless entry, management, and monitoring of advertising inventory data by the TV publisher 102. The publisher interface 106 may allow the TV publisher 102 to input details about their available inventory, set minimum price thresholds, and access analytics and optimization results that the system 100 generates. By providing a user-friendly and efficient means of interaction, the publisher interface 106 may ensure that TV publishers can effectively participate in and benefit from the optimization process.

The publisher interface 106 may be implemented in various technical forms, each designed to cater to different user needs and technological environments. For example, the publisher interface 106 may be implemented as a web-based interface accessible by the TV publisher 102 through a standard web browser. This may allow the TV publisher 102 to access the publisher interface 106 (and other components of the system 100) using any device that supports a web browser, without the need for installing specialized software. Alternatively, the publisher interface 106 may be implemented as a desktop application installed directly on the TV publisher 102's computer. The publisher interface 106 may be implemented as a cloud-based service that the TV publisher 102 accesses through secure authentication protocols, enabling access from multiple locations and devices while maintaining data security and consistency.

As yet another example, the publisher interface 106 may be implemented as a mobile application that is executable on mobile devices, such as tablets and smartphones. The publisher interface 106 may be offered as an API (Application Programming Interface) that allows the TV publisher 102's systems to communicate directly with the publisher interface 106 and with other components of the system 100. In some cases, the publisher interface 106 may be implemented as a command-line interface for advanced users or for automated script-based interactions. The publisher interface 106 may be implemented as a voice-activated interface, enabling hands-free operation in certain environments. The publisher interface 106 may be implemented as a hybrid solution combining multiple interface types, such as a web interface with mobile companion applications, or as a dashboard integrated into existing publisher management systems. The publisher interface 106 may include specialized data visualization tools, real-time analytics displays, and/or customizable reporting features to enhance the TV publisher 102's ability to monitor and manage inventory effectively.

The purpose of the publisher inputs 104 is to provide the necessary data that feeds into the optimization engine 126, thereby enabling it to make informed decisions about ad placement, pricing, and inventory management. The publisher inputs 104 directly influence the effectiveness of the optimization engine 126 in maximizing revenue and ensuring efficient use of advertising space.

Examples of data that may be included in the publisher inputs 104 include any one or more of the following:
Inventory Data: This includes detailed information about the TV publisher 102's available ad slots (also referred to as “ad avails”), such as the time slots, duration of the ads, specific channels, and/or any other relevant characteristics of the inventory that the TV publisher 102 wishes to sell.
Pricing Information: The TV publisher 102 may input minimum price thresholds for different ad slots, which serve as a baseline for the optimization process. This ensures that the inventory is not sold below a certain price, protecting the publisher's revenue interests.
Historical Performance Data: Information on the past performance of different ad slots may be provided by the TV publisher 102. This may include data on viewer ratings, previous ad revenues, and/or other metrics that help predict the future performance of these slots.
Demographic and Audience Insights: Data regarding the demographics of viewers for different time slots or programs may be useful for targeting specific advertiser needs. This includes age, gender, interests, and/or other demographic factors.
Regulatory and Compliance Information: Inputs regarding any legal or regulatory restrictions that apply to certain types of ads or specific content during certain times may be useful for ensuring that all ad placements are compliant with industry standards and laws.
Seasonal and Temporal Factors: Inputs that reflect seasonal viewership changes or special events that might affect ad performance. For example, increased viewer numbers during sports events or seasonal shows.
Feedback and Adjustments: Inputs based on feedback from previous ad campaigns, including adjustments that publishers wish to make based on what has or has not worked well in the past.
Price Minimum Data: The TV publisher 102 may specify lowest acceptable prices for ad slots on an hourly basis, allowing for granular control over pricing across different times of day.
Fee Structure Data: Information specifying a percentage of passthrough dollars to be charged to the TV publisher 102 for use of the system 100, where passthrough dollars comprise revenue that flows through the system 100 from advertisers to the TV publisher 102 for ad inventory sold.
Throttle Control Parameters: Settings that allow the TV publisher 102 to adjust the rate of inventory data flow within the system 100, enabling strategic control over how much inventory is made available at any given time.
Configuration Data for Future Time Periods: Specifications defining how far into the future (e.g., number of days) the optimization engine 126 may optimize ad placements, allowing the TV publisher 102 to plan inventory allocation strategically.
Sales Daypart Information: Data about different dayparts (e.g., Prime Time, Daytime, Fringe, Late Night) with hourly breakouts within each daypart, allowing for alignment with advertiser performance estimates on an hourly basis.
Campaign-Specific Price Minimums: The TV publisher 102 may set different price minimums for specific ad campaigns rather than applying uniform minimums across all inventory.
Optimization Method Preferences: The TV publisher 102 may specify which optimization method the optimization engine 126 may use, such as waterfalling from highest to lowest rates, maximizing inventory yield across all campaigns simultaneously, and/or a hybrid approach combining both methods.
Non-Preemptible Direct Response (DR) Settings: Price floor settings for non-preemptible DR ad slots, which may be significantly higher than standard ad slots to reflect the premium nature of guaranteed placements.
Multiple TV Network Management Parameters: For TV publishers 102 managing multiple networks, inputs may include network-specific settings and preferences for coordinated optimization across all networks.

The TV publisher 102 may throttle the amount of inventory provided within the publisher inputs 104 within a particular time period (e.g., daily). In other words, the TV publisher 102 may adjust the flow of inventory data that is provided to the system 100 within the publisher inputs 104, either increasing or decreasing the amount of inventory data provided within the publisher inputs 104 over time as desired based on any of a variety of considerations. Such throttling may be performed in any of a variety of ways, such as by the TV publisher 102 manually controlling the number of slots or percentage of total inventory to be made available within the publisher inputs 104; by using automated rules based on predefined criteria, such as market demand indicators, historical data, or predictive analytics; and/or by enabling real-time adjustments to inventory levels, enabling the TV publisher 102 to react immediately to changes in the market.

The throttling mechanism may include rate limiting controls that specify maximum inventory release rates per hour, day, or other time intervals, allowing publishers to maintain strategic control over inventory availability. Such controls may be implemented through configurable parameters that set minimum and maximum thresholds for inventory flow, with automatic scaling based on demand patterns or market conditions. The throttling capability may provide significant business benefits by enabling publishers to create scarcity-driven demand, optimize pricing through controlled supply release, and maintain inventory reserves for high-value opportunities or premium advertisers.

Publishers may use throttling to implement strategic inventory management approaches, such as releasing lower-value inventory first while holding premium slots for optimal pricing opportunities, or gradually increasing inventory availability as campaign deadlines approach to maximize urgency-based pricing. The system 100 may integrate throttling controls with the optimization engine 126, allowing the optimization process to adapt dynamically to varying inventory availability and adjust placement strategies accordingly. This integration may include feedback mechanisms that monitor optimization performance and automatically suggest throttling adjustments to improve revenue outcomes or campaign effectiveness.

The throttling system may provide analytics and reporting capabilities that track inventory release patterns, measure the impact of different throttling strategies on revenue and fill rates, and generate recommendations for optimal throttling configurations based on historical performance data. Regardless of how such throttling is performed, the system 100 and method 200 may perform any of the techniques disclosed herein on different portions of the publisher inputs 104, as such portions are received from the TV publisher 102 over time.

As will be described in more detail below, the optimization engine 126 may optimize for an amount of time into the future (e.g., some number of days) that is configurable by the TV publisher 102. Such configurability may be implemented in any of a variety of ways. For example, the system 100 may enable the TV publisher 102 to input data (within the publisher inputs 104) specifying the availability of ad slots for a range of future dates, such as the specific time slots available each day, the duration of each slot, and any special conditions or pricing that apply to different time periods. As another example, the system 100 may enable the TV publisher 102 to include future pricing strategies within the publisher inputs 104. This may include, for example, the ability to set different price floors or promotional pricing for specific periods, such as during high-demand events or seasons. The system 100 may enable the TV publisher 102 to specify any constraints or preferences that the optimization engine 126 should apply to the optimization process for a future time period (e.g., some number of days). This may include, for example, restrictions on the types of ads that may be placed by the optimization engine 126 during certain times and/or preferences for certain types of advertisers.

The system 100 may implement one or more automated methods for determining the optimal future time period based on historical data analysis, such as automatically extending the optimization window during periods of historically high demand or contracting it during slower periods. The system 100 may provide rule-based configuration options where the TV publisher 102 can establish conditional parameters that dynamically adjust the future time period based on inventory sell-through rates, revenue targets, or market conditions. Furthermore, the system 100 may offer calendar-based configuration tools allowing the TV publisher 102 to visually select and modify optimization time periods through an interactive interface, or API-based integration options enabling the TV publisher 102's existing inventory management systems to programmatically control the optimization time horizon.

Although the system 100 may provide the publisher inputs 104 to the optimization engine 126, it may be useful to process the publisher inputs 104 first to ensure that the publisher inputs 104 provided by the TV publisher 102 are transformed into a format that is best suited for use by the optimization engine 126. In particular, the publisher interface 106 may process the publisher inputs 104 in any of a variety of ways to generate processed publisher inputs 108. Such processing may be designed to enhance the usability, accuracy, and relevance of the data, facilitating more effective decision-making by the optimization engine 126.

Examples of processing that the publisher interface 106 may perform on the publisher inputs 104 to generate the processed publisher inputs 108 include any one or more of the following:
Data Validation and Cleansing: The publisher inputs 104 may be validated to check for any inaccuracies or inconsistencies. This may include correcting data errors, filling missing values, and removing any irrelevant or redundant information.
Data Standardization: The validated data may be standardized to ensure consistency across various data types and sources. This might involve converting data into a uniform format, scaling numerical values, or categorizing unstructured data into predefined classes.
Data Enrichment: To enhance the quality of the inputs, additional data might be appended from other sources. For example, integrating viewer demographic data from third-party analytics services to complement the publisher's own data.
Feature Extraction: Key features relevant to the optimization tasks may be extracted from the processed data. This may include deriving new variables such as potential viewer engagement scores based on historical performance and demographic insights.
Aggregation and Segmentation: Data may be aggregated or segmented based on certain criteria to better align with the optimization goals. For instance, inventory data might be grouped by time slots or viewer demographics to facilitate targeted ad placements. As a particular example, the TV publisher 102's ad avails (e.g., remnant ad avails) may be organized by hour within each broad daypart rotation (e.g., Prime Time, Daytime, Fringe, Late Night, etc.).

Two particular examples of data that the processed publisher inputs 108 may include are the TV publisher 102's available inventory 110 and the TV publisher 102's pricing data. These are merely examples, however, and do not constitute examples of the present invention.

Regardless of how the processed publisher inputs 108 are generated, and regardless of the contents of the processed publisher inputs 108, the system 100 provides the processed publisher inputs 108 as an input to the optimization engine 126. As will be described in more detail below, the optimization engine 126 uses the processed publisher inputs 108 to represent the TV publisher side of the optimization process.

The system 100 also includes an advertiser 114, which refers to any entity or entities that seeks to purchase advertisements. The advertiser 114 may include individual advertisers, groups of advertisers, advertising agencies, media buying agencies, programmatic advertising platforms, demand-side platforms (DSPs), brand management companies, marketing consultancies, advertising technology companies, or any intermediary entity acting on behalf of one or more advertisers. The advertiser 114 may encompass one or more non-profit organizations, government entities, political campaigns, educational institutions, or any other entity seeking to communicate messages through television advertising. The advertiser 114 may operate through various business models, including direct advertising, affiliate marketing, performance-based advertising, or any hybrid arrangement. The advertiser 114 may represent a single brand, multiple brands under common ownership, or a portfolio of unrelated brands managed by a common entity. The advertiser 114 may operate at local, regional, national, or international levels, and may range from small businesses to large multinational corporations. The advertiser 114 may engage with the system 100 on a one-time basis, recurring basis, or through ongoing relationships of varying duration. The advertiser 114 may interface with the system 100 directly or through various technological intermediaries, APIs, or integrated software platforms that facilitate advertising campaign management.

Although only one advertiser 114 is shown in FIG. 1 for ease of illustration and explanation, embodiments of the present invention may work in connection with one or a plurality of advertisers. As a result, any description herein of functions performed by or otherwise in connection with the advertiser 114 should be understood to be capable of being performed in connection with a plurality of advertisers.

The system 100 also includes an advertiser interface 118, which interfaces with the advertiser 114. The advertiser 114 may provide any of a variety of advertiser inputs 116 to the advertiser interface 118 (FIG. 2, operation 204). The advertiser interface 118 may be implemented in any of a variety of forms, such as any of the forms mentioned in connection with the publisher interface 106. For example, the advertiser interface 118 may be implemented as a web-based interface accessible through a standard web browser, a desktop application installed directly on the advertiser 114's computer, a cloud-based service accessed through secure authentication protocols, a mobile application executable on tablets and smartphones, an API (Application Programming Interface) allowing direct communication with the advertiser 114's systems, a command-line interface for advanced users, a voice-activated interface, or a hybrid solution combining multiple interface types. In some cases, the advertiser interface 118 may include specialized data visualization tools, real-time analytics displays, and/or customizable reporting features to enhance the advertiser 114's ability to monitor and manage campaigns effectively.

Examples of the advertiser inputs 116 include any one or more of the following:
Campaign Requirements: This may include, for example, specifications of the advertiser 114's advertising campaign, such as the target audience, desired reach, type of ads (e.g., video, banner), and preferred content themes. These requirements help the system 100 to understand what the advertiser 114 aims to achieve through its campaign.
Budget Constraints: The advertiser 114 may specify its total budget and how it should be allocated. This may include, for example, overall budget maximums, as well as more granular allocations, such as budget percentages designated for different networks or specific times of the day (dayparts).
Flight Dates: These are the start and end dates for the campaign. Providing flight dates helps the system 100 to schedule the advertisements precisely within the desired timeframe, ensuring that ads are aired during periods that align with the advertiser's marketing strategy and audience availability.
Separation Requirements: This refers to the rules regarding the spacing of ad placements to avoid saturation. The advertiser 114 may specify minimum intervals between its ads or between its ads and those of competitors, or it might request that its ads not be aired in certain contexts (e.g., adjacent to competing products or unsuitable content).
Performance Targets: The advertiser 114 may include desired outcomes, such as expected impressions, click-through rates, or conversion metrics. These targets assist the optimization engine 126 in selecting inventory that is likely to achieve these results.
Geographic Preferences: This includes preferences or restrictions on where the ads should be shown, which may range from national coverage to more localized geographic targeting. This helps in aligning the ad placements with the geographical distribution of the target audience.
Creative Constraints: These relate to the creative aspects of the ads, such as length, format, or specific content restrictions that comply with brand guidelines or regulatory standards.
Ad Separation: This refers to the minimum time interval required between consecutive advertisements from the same advertiser. The advertiser 114 may, for example, specify the duration of separation to prevent ad clutter and enhance viewer engagement. Ad separation may also include competitive separation requirements, wherein advertisements from different advertisers within the same product or service category may not be placed within the same ad break. For example, the advertiser 114 may specify that no automotive advertisements from competing manufacturers should air during the same ad break as the advertiser 114's automotive advertisement.
Program Exclusions (Blacklists): The advertiser 114 may, for example, specify certain programs and/or types of content from which they wish to exclude their ads. This could be due to brand safety concerns, audience misalignment, or other strategic reasons. By setting program exclusions, the advertiser 114 ensures that their advertisements do not appear in contexts that could potentially harm their brand image or waste budget on uninterested audiences.
Time Period Exclusions: This allows the advertiser 114 to exclude specific times during which they do not want their ads to run. These exclusions may be based on any of a variety of factors, such as low audience engagement periods, times when target demographics are less likely to be watching, or during content that does not align with the advertiser 114's brand values or campaign goals.
Daypart Targeting: The advertiser 114 may specify particular parts of the day, known as dayparts, during which they want their ads to be aired. This targeting allows for more precise alignment with audience availability and behavior patterns. Common dayparts include Morning, Daytime, Primetime, and Late Night.
Desired Reach and Frequency: The advertiser 114 may specify the desired reach (the number of unique viewers targeted) and frequency (the number of times each viewer should see the ad). This input helps the system 100 to optimize the distribution of the campaign across different networks and times to achieve the ideal balance of exposure and repetition.
Cost Per Outcome (CPO) Goals: The advertiser 114 may specify target costs they are willing to pay for each desired outcome (such as a sale, lead, or other specific action). These CPO goals serve as benchmarks for the optimization engine 126 to evaluate and select cost-effective advertising slots that align with the advertiser's budget and performance objectives.
Placement Parameters: These define specific conditions for where and how ads should be placed, including preferences for certain networks, programs, or contextual environments that align with the advertiser's brand and campaign objectives.
Non-preemptible Direct Response (DR) Designation: The advertiser 114 may designate certain ad placements as non-preemptible DR, indicating a willingness to pay premium rates for guaranteed placement that cannot be displaced by other ads.
Cost Per Mille (CPM) Bids: For audience-based optimization, the advertiser 114 may provide CPM bids that specify the amount they are willing to pay per thousand impressions, broken down by hour to enable more precise targeting and budget allocation.
Audience Estimates: The advertiser 114 may provide projections of expected audience size per hour, which can be used in conjunction with CPM bids to calculate unit rates for ad placements using the formula: Unit Rate=CPM×Audience Estimate.
Multiple Network Campaign Parameters: For campaigns spanning multiple TV networks, the advertiser 114 may provide specific parameters for coordinated optimization across all networks, potentially with different CPO targets for each network within the same campaign framework.

The advertiser inputs 116 allow the optimization process to be customized to the specific needs and preferences of each advertiser, enhancing the relevance and effectiveness of ad placements. By providing detailed requirements and constraints, advertisers can maximize the efficiency of their ad spend, ensuring that their budget is used in the most effective way possible. Inputs related to creative constraints and separation requirements ensure that all ad placements comply with brand standards and regulatory requirements, maintaining the integrity of the advertiser's brand. Inputs such as flight dates and geographic preferences ensure that the campaign is aligned with broader marketing strategies and objectives, such as targeting specific events or regional markets.

The advertiser inputs 116 may include performance estimates. These may be used by the system 100 to enhance the precision and effectiveness of the ad placement process. These performance estimates may align with the hourly breakouts of the sales dayparts provided by the TV publisher 102 in the publisher inputs 104. This alignment ensures that each hour within a daypart is associated with a specific performance estimate from the advertiser 114.

The performance estimates may include projected metrics that the advertiser 114 expects to achieve from its ad placements during specific hours within the dayparts. These metrics may include, for example, anticipated viewer engagement rates, click-through rates, conversion rates, or any other relevant performance indicators. The function of these estimates is to provide a quantitative basis for making informed decisions about where and when to place advertisements to maximize their effectiveness.

The advertiser inputs 116 may also include a Cost Per Outcome (CPO) goal of the advertiser 114. This CPO goal represents the target cost that the advertiser 114 is willing to pay for each desired outcome, such as a sale, lead, or other specific actions resulting from their ad placements. The CPO goal functions as a benchmark for the optimization engine 126 to evaluate and select the most cost-effective advertising slots that align with the advertiser 114's budget and performance objectives. It allows the system 100 to calculate the expected return on investment for different ad placements and to prioritize those that are likely to achieve the desired outcomes within or below the specified CPO.

The CPO goal helps advertisers manage their advertising budgets more effectively by setting a clear cost threshold for each outcome. This ensures that the advertising spend is directly tied to measurable results, enhancing financial accountability and efficiency. By providing a CPO goal, advertisers enable the optimization engine 126 to focus on securing ad slots that are not only likely to perform well but are also cost-effective. This strategic alignment helps in maximizing the impact of each ad dollar spent.

The system 100 ensures that the advertiser 114's CPO and performance estimates are not shared with the TV publisher 102. Keeping the CPO confidential prevents any potential manipulation of prices by TV publishers. If publishers were aware of the maximum cost advertisers are willing to pay per outcome, they might set their prices close to this threshold, which could lead to inflated advertising costs. Furthermore, advertisers'strategies and financial thresholds are sensitive information. Protecting this data helps maintain the advertisers'competitive advantage and prevents any misuse of the information. By withholding specific performance goals and cost metrics from publishers, the system 100 promotes a fairer and more competitive marketplace. Publishers set their prices based on market dynamics and the intrinsic value of their inventory, rather than the advertisers'budget constraints.

The system 100 may implement various technical mechanisms to ensure that the advertiser 114's CPO and performance estimates are not shared with the TV publisher 102. In some embodiments, the system 100 may utilize data segregation techniques where advertiser data and publisher data are stored in separate, isolated databases or data structures within the storage module 130. The optimization engine 126 may access both data sets independently without creating any shared data repositories that could expose sensitive advertiser information to publishers. The system 100 may employ role-based access controls that restrict data visibility based on user authentication and authorization levels. Publisher interfaces may be configured with access permissions that prevent retrieval or display of advertiser CPO data and performance estimates, while still allowing publishers to input their own inventory and pricing information.

In some cases, the system 100 may implement data encryption mechanisms where advertiser CPO goals and performance estimates are encrypted using cryptographic algorithms before storage and processing. The encryption keys may be managed separately from publisher-accessible systems, ensuring that even if data is inadvertently accessed, it remains unreadable without proper decryption credentials.

The optimization engine 126 may utilize abstraction layers that process advertiser data internally without exposing the underlying values to publisher-facing components. The engine may generate optimization results and recommendations without revealing the specific CPO targets or performance metrics that influenced those decisions.

In some embodiments, the system 100 may employ data masking or anonymization techniques where advertiser-specific metrics are processed in aggregate or statistical forms that do not reveal individual campaign details to publishers. The system may also utilize secure computation methods that allow optimization calculations to be performed on encrypted or obfuscated data without exposing the raw values.

Overall, including the CPO goal in the advertiser inputs 116 and keeping it confidential from TV publishers are practices that enhance the strategic, financial, and operational effectiveness of the advertising process. These measures ensure that the system 100 operates with integrity, aligning ad placements with both the advertisers'performance goals and budgetary considerations, while fostering a competitive and unbiased advertising marketplace.

Although the system 100 may provide the advertiser inputs 116 to the optimization engine 126, it may be useful to process the advertiser inputs 116 first to ensure that the advertiser inputs 116 provided by the advertiser 114 are transformed into a format that is best suited for use by the optimization engine 126. In particular, the advertiser interface 118 may process the advertiser inputs 116 in any of a variety of ways to generate processed advertiser inputs 120. Such processing may be designed to enhance the usability, accuracy, and relevance of the data, facilitating more effective decision-making by the optimization engine 126.

Examples of processing that the advertiser interface 118 may perform on the advertiser inputs 116 to generate the processed advertiser inputs 120 include any of the kinds of processing described above in connection with the publisher inputs 104, such as data validation and cleansing, data standardization, data enrichment, feature extraction, and aggregation and segmentation.

Three particular examples of data that the processed advertiser inputs 120 may include are the advertiser 114's campaign requirements 122, CPO goal 123, and performance targets 124. These are only examples, however, and do not constitute limitations of the present invention.

Regardless of how the processed advertiser inputs 120 are generated, and regardless of the contents of the processed advertiser inputs 120, the system 100 provides the processed advertiser inputs 120 as input to the optimization engine 126. As will be described in more detail below, the optimization engine 126 uses the processed advertiser inputs 120 to represent the advertiser side of the optimization process.

One the advertiser 114 (and any other advertisers) have provided information about their ad campaigns to the system 100 using the techniques disclosed herein, the system 100 may enable the TV publisher 102 (and any other publishers) to view information about such ad campaigns. The system 100 may, for example, display or otherwise provide to the TV publisher 102 details about the campaigns, such as the campaign's duration, and possibly the intended ad spend.

The system 100 may enable the TV publisher 102 to set price minimums (e.g., by the hour) for each ad campaign. This means that for any given hour, a publisher may determine the lowest price at which they are willing to sell their ad inventory. This capability enhances the control and flexibility publishers have over their inventory and pricing, leading to optimized revenue management and more effective partnerships with advertisers.

By setting hourly price minimums, publishers may strategically manage their ad inventory to maximize revenue. During hours when demand is expected to be high, publishers may set higher price floors, ensuring that they capitalize on the increased advertiser interest. This feature empowers publishers with greater control over their inventory. They can adjust pricing dynamically based on real-time market conditions and the specifics of the registered campaigns, allowing them to respond quickly to changes in demand or advertiser interest.

This feature also provides benefits to the advertiser 114 and other advertisers. For example, this feature ensures that advertisers have fair access to advertising slots. Advertisers benefit from the ability of publishers to adjust pricing based on the campaign specifics. This can lead to more targeted advertising opportunities, as publishers might lower prices during less competitive hours, allowing advertisers to reach their desired audience cost-effectively. Knowing that publishers can see their campaigns and set prices accordingly allows advertisers to strategize better and tailor their campaigns to fit the pricing and timing that will most likely result in optimal ad placements.

The system 100 may maintain confidentiality of certain information about the TV publisher 102 by not sharing such information with the advertiser 114. Examples of such information include the amount of inventory placed by the TV publisher 102 on the system 100 and the TV publisher 102's minimum pricing. This confidentiality ensures a fair and unbiased marketplace, protecting the strategic interests of both publishers and advertisers. The system 100 may implement various technical mechanisms to ensure that the TV publisher 102's inventory amounts and minimum pricing are not shared with the advertiser 114. These mechanisms may include any of the technical approaches mentioned elsewhere in connection with maintaining confidentiality of advertiser information, such as data segregation techniques where publisher and advertiser data are stored in separate, isolated databases within the storage module 130, role-based access controls that restrict data visibility based on user authentication levels, data encryption mechanisms where publisher inventory and pricing data are encrypted using cryptographic algorithms, abstraction layers that process publisher data internally without exposing the underlying values to advertiser-facing components, and data masking or anonymization techniques where publisher-specific metrics are processed in aggregate forms that do not reveal individual inventory details to advertisers.

For example, maintaining confidentiality of inventory amounts prevents any potential manipulation of demand or strategic behavior based on inventory levels. Similarly, maintaining confidentiality of the minimum pricing set by the publisher for their inventory helps maintain a competitive and unbiased pricing environment. More generally, maintaining such confidentiality ensures that both parties engage in transactions based on the intrinsic value and potential performance of the advertising opportunities, rather than strategic manipulation of market information. This leads to more efficient and effective outcomes for all parties involved.

The optimization engine 126 within the system 100 harmonizes and optimizes the advertising goals of both the TV publisher 102 and the advertiser 114. The optimization engine 126 leverages the processed publisher inputs 108 and the processed advertiser inputs 120 to create a balanced and effective advertising strategy that meets the needs of both parties.

More specifically, the optimization engine 126 performs a dual-sided optimization that considers the objectives and constraints of both the TV publisher 102 and the advertiser 114, based on the processed publisher inputs 108 and the processed advertiser inputs 120, respectively. For example, the optimization engine 126 may use the processed publisher inputs 108 to understand the inventory availability, pricing strategies, and desired revenue targets of the TV publisher 102. It aims to optimize the placement and pricing of ads in a way that maximizes revenue while maintaining inventory integrity and meeting publisher constraints.

Simultaneously, the optimization engine 126 may consider the advertiser 114's campaign requirements, budget constraints, performance targets, and desired outcomes, as specified by the processed advertiser inputs 120. The optimization engine 126 may seek to place ads in a manner that maximizes campaign effectiveness and ROI for the advertiser 114.

By integrating and balancing these diverse inputs, the optimization engine 126 ensures that both parties achieve their respective goals without compromising the other's interests. In contrast, conventional advertisement placement optimizers typically operate with a bias towards either the seller (e.g., Supply-Side Platforms (SSPs)) or the buyer (e.g., Demand-Side Platforms (DSPs)). These systems are designed to maximize outcomes for one side of the market transaction only. In contrast, the optimization engine 126 is uniquely neutral and designed to benefit both sides.

The fee structure for the use of system 100, specifically the optimization engine 126, may take any of a variety of forms. For example, fees may be paid by the TV publisher 102 as a percentage of passthrough dollars. “Passthrough dollars” refers to the revenue that flows through the system 100 from advertisers to publishers for the ad inventory sold. Charging publishers fees as a percentage of passthrough dollars aligns the costs of using the system 100 with the revenue generated by the system 100, thereby creating a mutually beneficial scenario for both publishers and advertisers. For example, this fee structure minimizes financial risk for publishers. Since fees are only paid out of the revenue generated, publishers are not required to make upfront payments or pay fixed fees that might be burdensome if the ad slots do not sell as expected. Furthermore, because the system 100's revenue is tied to the success of the publishers'sales, the system 100's operators are motivated to continuously improve the system 100 and its optimization algorithms to maximize the effectiveness and revenue potential of the ad inventory.

Another benefit of this revenue model is that it enables publishers to better manage their cash flow as the fees are deducted from the revenue as it is earned. This avoids the need for separate budgeting or financial planning for the costs associated with using the system. Furthermore, this model encourages fair pricing of ad slots. Publishers are incentivized to set competitive prices to attract advertisers, knowing that their earnings (and thus their fees to the system 100) depend on successful sales. With publishers motivated to maximize their passthrough dollars, there is a natural alignment towards optimizing the inventory to meet advertisers'needs effectively.

The optimization engine 126 may perform optimization based on the processed publisher inputs 108 and the processed advertiser inputs 120 in any of a variety of ways (FIG. 2, operation 206). For example, the optimization engine 126 may calculate the hourly unit rate paid for each ad slot using the formula:

Hourly Unit Rate Paid=CPO*Performance Estimate

The system 100 may provide flexibility in the time granularity used for calculating unit rates, allowing for calculations based on various time intervals beyond the hourly examples described above. In some embodiments, unit rates may be calculated by minute, by 5 minutes, by 10 minutes, by 15 minutes, by 30 minutes, or by any other suitable time fraction that aligns with the operational needs of the TV publisher 102 and the campaign requirements of the advertiser 114. This flexibility enables more precise optimization and targeting based on specific programming schedules and audience behavior patterns.

The system 100 may support segmentation of programming rotations into smaller time segments, each with individual performance estimates. For example, a broad programming rotation of 9 hours may be broken into three separate 3-hour segments, with the advertiser 114 providing distinct performance estimates for each 3-hour segment. This segmentation approach allows for more granular optimization that accounts for varying audience engagement and performance characteristics throughout different portions of extended programming blocks. The optimization engine 126 may then calculate unit rates for each segment using the formula of CPO multiplied by the segment-specific performance estimate, enabling more targeted ad placement decisions within longer programming rotations.

Such flexible time granularities and segmentation capabilities may be particularly useful for accommodating different types of programming content, varying audience viewing patterns throughout the day, and specific advertiser targeting strategies. The system 100 may enable both the TV publisher 102 and the advertiser 114 to specify their preferred time granularity for optimization calculations, allowing the optimization engine 126 to adapt its calculations accordingly while maintaining the core optimization objectives of maximizing publisher revenue and achieving advertiser CPO goals.

The CPO is the cost that the advertiser 114 is willing to pay for each desired outcome, such as a sale, lead, or other measurable actions. The CPO is the cost that the advertiser 114 is willing to pay for each desired outcome, such as a sale, lead, or other measurable actions. The performance estimate predicts how well an ad will perform in a specific time slot based on one or more factors, such as historical data, audience demographics, viewing patterns, seasonal trends, day-of-week variations, competitive programming, content genre affinity, previous campaign performance, geographic response rates, device usage patterns, and/or other relevant factors that may influence viewer engagement and conversion rates. The performance estimate quantifies expected outcomes, helping to align ad placements with the most promising opportunities. Instead of a performance estimate, a lift estimate may be used. A lift estimate is a projection or calculation that quantifies the expected increase in a specific business outcome as a result of an advertising campaign, such as an increase in sales, brand awareness, website traffic, or other measurable metrics.

Using the calculated hourly unit rates, the optimization engine 126 may strategically place ads into time slots that maximize revenue for the TV publisher 102 while also striving to meet all the campaign requirements set by the advertiser 114. This dual-objective approach ensures that ads are placed in time slots where they are expected to generate the highest revenue for the TV publisher 102, while also ensuring that the placement of ads aligns with the advertiser 114's campaign requirements, such as target audience, desired time frames, and budget constraints.

Any results of the optimization(s) performed by the optimization engine 126 are output in optimization outputs 128. The optimization outputs 128 may include any of a variety of data types and structures that represent the results of the optimization process. For example, the optimization outputs 128 may include one or more ad placement schedules that specify which advertising campaigns are to be placed in which available time slots across the TV publisher 102's inventory. These schedules may be organized by date, time, network, program, and/or daypart to provide a comprehensive view of how advertisements are distributed across the available inventory. The optimization outputs 128 may include calculated unit rates for each ad placement, showing the specific rates determined by the optimization engine 126 based on the CPO goals and performance estimates provided by the advertiser 114.

The optimization outputs 128 may include revenue projections for the TV publisher 102, detailing expected revenue from each placed advertisement and aggregated revenue across different time periods, networks, or dayparts. The optimization outputs 128 may contain performance metrics for the advertiser 114, such as projected outcomes, estimated reach, and/or expected CPO achievement based on the optimized placements. The optimization outputs 128 may include inventory utilization statistics showing what percentage of available inventory has been allocated and what remains available for future optimization.

At a more granular level, the optimization outputs 128 may include detailed placement data for each advertisement, such as the specific time slot, program context, expected audience demographics, and/or calculated performance metrics. For non-preemptible DR placements, the optimization outputs 128 may include special flags and/or indicators that mark these placements as guaranteed. The optimization outputs 128 may contain data about price floor adjustments made during the optimization process, particularly when using methods that involve relaxing or eliminating price floors to maximize inventory yield.

In practice, the optimization outputs 128 may be structured as multi-dimensional data arrays or relational database entries that capture the complex relationships between advertisers, campaigns, publishers, inventory, and performance metrics. For example, a practical implementation may include a placement table with columns for campaign ID, network, date, time, program, unit rate, expected performance, and placement status. Another example of a table may track budget allocation and utilization across campaigns, showing initial budget, allocated budget, remaining budget, and projected performance against CPO goals. The system 100 may generate any of a variety of outputs based on the optimization outputs 128, and provide (e.g., display) such generated outputs to the TV publisher 102 and/or the advertiser 114 in any of a variety of ways, such as in one or more files, messages, or user interfaces.

The system 100 may store the optimization outputs 128 in a storage module 130, such as a database. The system 100 may store multiple instances of the optimization outputs 128 in the storage module 130 over time. As a result, the storage module 130 may contain a plurality of stored optimization outputs 128 that are accumulated over time. The system 100 may retrieve any such optimization outputs 128 from the storage module 130.

The system 100 may enable both the TV publisher 102 and the advertiser 114 to modify their inputs (e.g., the publisher inputs 104 and the advertiser inputs 116) on a regular basis, such as daily. This capability to adjust various parameters including inventory details, pricing strategies, and campaign specifics in real-time is useful for enabling the TV publisher 102, the advertiser 114, and the system 100 as a whole to adapt to the ever-changing market conditions and optimizing the outcomes of advertising campaigns. After such updates to the publisher inputs 104 and/or the advertiser inputs 116 are received, the optimization engine 126 may perform operation 206 again to produce different optimization outputs 128 based on these updated inputs, thereby ensuring that ad placements remain optimized as conditions change.

For example, the system 100 may enable the TV publisher 102 to adjust the amount and type of inventory they wish to make available for optimization. This could be in response to changes in programming, viewer demographics, or unsold inventory that needs to be filled. As another example, the system 100 may enable the TV publisher 102 to modify the minimum prices they set for their inventory slots. This allows them to respond to market demand, competitor pricing, and other external economic factors to maximize revenue.

Similarly, the system 100 may enable the advertiser 114 to adjust its CPO based on the performance of its ads and changes in its marketing objectives. For instance, if an ad performs exceptionally well, the advertiser 114 might increase the CPO to secure more premium slots. As campaigns progress, the system 100 may enable the advertiser 114 to update its performance estimates to reflect actual ad performance and viewer engagement metrics. This helps in recalibrating the optimization strategies to be more aligned with real-world outcomes. The system 100 may also enable the advertiser 114 to change its campaign requirements, such as target demographics, desired time slots, and specific geographic areas to better align with evolving marketing strategies or to test different approaches.

The optimization engine 126 may use any of a variety of optimization methods. Furthermore, the system 100 may enable the TV publisher 102 to choose which of a plurality of optimization methods to be used by the optimization engine 126. This allows publishers to align their inventory management and revenue optimization approaches with their specific business needs and market conditions.

One method that the optimization engine 126 may use to perform optimization is to maximize revenue from each separate ad campaign and to optimize for inventory yield by waterfalling from highest to lowest rates (the “waterfalling method”). This method is particularly effective for ensuring that the ad inventory is utilized efficiently, maximizing revenue by adapting to the highest bidder for each specific hour within the ad inventory.

In the waterfalling method, the optimization process begins by evaluating the rates advertisers are willing to pay for each unit of time, such as an hour. Unit rates are assessed on a time-unit basis (e.g., hourly), identifying the highest rate offered by any advertiser for each time unit. This approach allows for dynamic adjustment to the varying willingness of different advertisers to pay across different time periods, ensuring that the most valuable slots are allocated to the highest bidders for each time unit. While hours are used as an example of a time unit herein, any reference to an hour as a unit of time in connection with an optimization method should be understood to be equally applicable to other units of time, such as minutes, half-hours, or multi-hour blocks.

Once the highest rates for each hour are determined, the optimization engine 126 allocates the best available inventory to the campaigns offering those rates. Premium inventory typically includes time slots that have the highest viewer engagement or are most sought after by advertisers due to their potential to reach target audiences effectively. Examples of premium inventory include prime-time slots (typically 8-11 PM), slots during popular sporting events, season finales of hit shows, holiday specials, slots adjacent to breaking news coverage, first commercial break positions within programs, inventory during award shows, slots during season premieres, and inventory with demographic-specific high viewership such as children's programming on weekend mornings.

After allocating slots to the highest bidders of each hour, the system 100 continues the optimization process for the remaining available hours. This “waterfalling” process ensures that each hour is evaluated independently, allowing different advertisers to secure premium slots based on their specific hourly bids. As a result, this method ensures that all available inventory is utilized efficiently, with each slot filled in a way that maximizes revenue based on the highest available rate for each hour.

Throughout the process, the optimization engine 126 repeatedly (e.g., continuously) assesses the yield from the inventory. The goal is to not only fill the slots but to do so in a manner that maximizes overall revenue. This involves strategic decisions about which campaigns are placed in which slots based on the expected revenue generation and the specific characteristics of the inventory.

By prioritizing higher-paying campaigns for premium slots, the waterfalling method ensures that revenue potential is maximized. Each campaign is placed in a manner that leverages its willingness to pay, thereby optimizing revenue from the inventory. The sequential filling of inventory from highest to lowest rates ensures that all available slots are utilized effectively. This reduces the likelihood of unsold inventory and maximizes the overall yield. Furthermore, the waterfalling method allows for strategic placement of ads, aligning them with the times and contexts that are most likely to generate high viewer engagement and advertiser satisfaction. Although the waterfalling method is structured, it still allows for flexibility in handling sudden changes in inventory availability or advertiser demand.

A second method that the optimization engine 126 may use to perform optimization is to focus on maximizing the inventory yield from all ad campaigns simultaneously. This approach is designed to optimize the overall revenue generation across the entire inventory, rather than focusing on individual campaigns. It involves strategic management of price floors and dynamic adjustment of pricing strategies to enhance inventory utilization and maximize total yield.

In this second optimization method, the optimization engine 126 begins with a comprehensive analysis of the entire available inventory within the system 100. This analysis considers various factors such as viewer demographics, historical performance data, time slots, and the specific characteristics of different inventory segments. The optimization engine 126 may employ AI algorithms to analyze market conditions and determine which price floors can be strategically relaxed and by what specific amounts to create higher yield opportunities. The AI may evaluate multiple market indicators including current demand levels, historical sell-through rates for similar inventory, competitive pricing pressures, seasonal demand patterns, and advertiser bidding behaviors to assess the potential impact of price floor adjustments. The AI decision-making process may involve analyzing the trade-offs between maintaining higher price floors for revenue protection versus relaxing them to increase inventory utilization and overall yield.

Simultaneously, the optimization engine 126 evaluates all active ad campaigns registered by advertisers. This evaluation includes assessing the budget, target audience, desired outcomes, and the willingness to pay (CPO) of each campaign. The goal is to understand the demand landscape across all campaigns to inform the optimization strategy.

Based on the analysis of inventory and campaign demands, the optimization engine 126 may relax or eliminate the price floors for different segments of the inventory. The AI may implement sophisticated decision-making algorithms that evaluate the risk-reward balance of price floor adjustments, considering factors such as inventory scarcity, time sensitivity, and historical performance of similar adjustments. Machine learning models may predict the optimal degree of price floor relaxation by analyzing patterns in past campaigns where price floor modifications resulted in improved yield outcomes. The AI may use predictive analytics to determine the specific percentage by which price floors should be reduced for different inventory segments, taking into account the probability of increased sell-through rates and the potential impact on overall revenue. Relaxing or eliminating these floors may enable more inventory to be filled during lower demand periods to maximize revenue while maintaining strategic pricing control for premium inventory segments.

The ultimate goal of this second optimization method is to maximize the total yield from the inventory. This involves making strategic decisions about which price floors to adjust and by how much, based on real-time data and predictive analytics. The AI may employ reinforcement learning techniques that continuously evaluate the outcomes of price floor adjustments and refine the decision-making process over time. The system may use historical learning capabilities to identify patterns in successful price floor relaxation strategies, building a knowledge base of which types of inventory segments respond favorably to specific degrees of price reduction. Real-time monitoring algorithms may track the immediate impact of price floor changes on advertiser bidding behavior and inventory fill rates, enabling dynamic adjustments to the extent of price floor relaxation based on observed market responses. The optimization engine 126 continuously monitors the performance and adjusts the strategy to ensure optimal revenue generation across all campaigns, with AI algorithms providing recommendations for when to restore original price floors if market conditions change or when relaxation strategies are not yielding expected results.

By focusing on the total yield, this second optimization method ensures that the overall revenue from the inventory is maximized. It allows for a holistic approach to revenue management that considers the collective performance of all campaigns. Furthermore, dynamic relaxing of price floors helps in significantly increasing the inventory utilization rate. Relaxing price floors during less popular times can fill slots that would otherwise go unsold. This method provides high flexibility and adaptability to changing market conditions. In addition, by adjusting price floors based on overall campaign demand, this second method of optimization ensures a more balanced participation of advertisers. For example, it prevents scenarios where high-paying advertisers dominate premium slots, allowing more advertisers to participate effectively.

A third method that the optimization engine 126 may use to perform optimization is to combine the strategies of the first two methods. This third method initially focuses on maximizing revenue from each individual ad campaign and then shifts to optimizing the overall inventory yield by strategically managing unspent budgets and adjusting price floors. This dual-phase approach ensures both targeted revenue maximization for high-value campaigns and efficient utilization of the entire inventory.

More specifically, the third optimization method starts by using the first method above to prioritize ad campaigns based on their potential revenue contribution. The highest-paying campaigns are allocated the most desirable ad slots. This ensures that the most valuable inventory is used to generate maximum revenue from these top-tier campaigns. As these campaigns run, their performance and expenditure are closely monitored to ensure they are meeting their targeted outcomes and spending their allocated budgets effectively.

After maximizing individual campaign revenues, the optimization engine 126 reviews all campaigns to identify those with remaining or unspent budgets. These are typically campaigns that may not have fully utilized their allocated funds during the initial phase. For campaigns with unspent budgets, the optimization engine 126 then adjusts the price floors. This involves lowering the price floors to make the remaining inventory more attractive and accessible, thereby encouraging advertisers to increase their spending to utilize their full budgets. The inventory that was not initially used or was underutilized is now re-allocated to these campaigns. The goal is to fill up all available slots while still trying to maximize the overall yield from these additional allocations.

This third optimization method ensures that revenue is maximized both at the individual campaign level and across the entire inventory. It starts with a focus on high-value campaigns and then extends to optimizing the use of all available resources. By focusing on campaigns with unspent budgets in the second phase, the third method helps advertisers fully utilize their allocated funds. This not only maximizes the campaign's impact but also ensures that advertising budgets are spent efficiently. Furthermore, the third (hybrid) method offers greater flexibility by combining two effective strategies. It allows the system 100 to adapt to various scenarios, such as when some campaigns underperform in spending or when additional inventory becomes available unexpectedly. The third method balances the need for targeted, high-value ad placements with the necessity to maximize overall inventory usage, leading to a more strategic and balanced approach to ad placement.

The system accommodates a specialized form of direct response (DR) buying known as guaranteed or non-preemptible DR. This buying model is particularly valuable for advertisers who require certainty in their ad placements, ensuring that their ads are not preemptable and will definitely be aired as scheduled. In non-preemptible DR buying, advertisers agree to pay a premium, often nearly double the standard rate, to secure their ad placements against preemption. This arrangement ensures that once an ad slot is booked, it cannot be displaced by other ads, providing advertisers with the highest level of placement security.

The traditional process of buying DR advertising has remained largely unchanged for the past 70 years, often characterized by its complexity, high costs, and inefficiency at scale. Embodiments of the present invention revolutionize this outdated model by making DR buying significantly easier, more cost-effective, and scalable, all without adding any additional costs to advertisers.

The system 100 may facilitate non-preemptible DR buying through a mechanism that integrates seamlessly with the existing optimization and pricing structures of the system 100. For example, to enable guaranteed DR buying, the system 100 may enable the advertiser 114 to provide input, such as via a simple user interface element (e.g., a checkbox labeled “Guarantee Placement”), to designate a particular ad placement as non-preemptible DR. When the advertiser 114 selects this option, the system 100 may automatically categorize the ad placement as non-preemptible DR, and therefore as non-preemptable. The system 100 may apply a significantly higher price floor to non-preemptible DR ad slots than to other ad slots, where such a higher price floor may be set by the TV publisher 102. For example, the price floor for non-preemptible DR ad slots may be set at 75-100% higher than standard ad slots, typically ranging from 1.75 to 2 times the base rate of comparable preemptible inventory. In some implementations, the premium may be dynamically calculated based on demand factors, with minimum premiums of 50% during low-demand periods and up to 150% during high-demand events such as major sports broadcasts or season premieres.

More specifically, the optimization engine 126 may recognize the fixed DR flag that has been applied to an ad slot and adjust the ad placement algorithms accordingly. The optimization engine 126 may adjust ad placement algorithms in any of a variety of ways, such as:
Implementing priority-based placement algorithms that ensure non-preemptible DR ads are scheduled first before allocating remaining inventory;
Applying specialized pricing algorithms that automatically calculate the premium rates for non-preemptible DR slots based on the TV publisher 102's specified price floor multipliers;
Modifying inventory allocation algorithms to reserve specific high-value time slots exclusively for non-preemptible DR placements when such placements are requested;
Implementing conflict resolution algorithms that prevent any potential scheduling conflicts between non-preemptible DR ads and other ad types, ensuring the guaranteed nature of these premium placements is maintained throughout the optimization process; and
Adjusting forecasting algorithms to account for the impact of non-preemptible DR placements on overall inventory availability, helping the TV publisher 102 maintain appropriate inventory balance between guaranteed and non-guaranteed placements.

Implementing the non-preemptible DR option within the system 100 allows TV publishers to manage and monetize their premium ad inventory effectively, ensuring that they can offer these high-value slots to advertisers willing to pay a premium for guaranteed visibility.

Embodiments of the present invention may drive down costs of buying DR ads by using a highly favorable fee structure. For example, TV publishers may pay a small fee based on the dollars that pass through the system 100. This fee may be tied directly to the revenue generated through the system 100, ensuring that publishers only pay in proportion to the value they receive. On the other hand, advertisers may incur no additional costs when using the system 100. This approach not only makes the system 100 attractive for advertisers but also aligns the interests of the publishers with the performance of the campaigns, fostering a more cooperative and productive relationship between all parties involved.

In some embodiments, the system 100 may implement a portfolio-level optimization approach that operates across designated supply channels. This approach may involve the TV publisher 102 or the system 100 selecting a specific set of supply channels for optimization, where supply channels may include particular TV networks, specific dayparts, program genres, inventory tiers, or other defined segments of available advertising inventory.

The optimization engine 126 may aggregate all active advertiser demand from multiple campaigns and advertisers simultaneously, creating a comprehensive demand portfolio. Rather than optimizing campaigns individually or sequentially, the optimization engine 126 may process this aggregated demand against the designated set of supply channels as a unified optimization problem.

This portfolio-level approach may enable the system 100 to identify optimization opportunities that would not be apparent when considering campaigns in isolation. For example, the optimization engine 126 may determine that shifting one campaign to a different time slot within the designated supply channels creates availability for a higher-paying campaign, resulting in increased overall yield for the TV publisher 102 across the entire portfolio.

The TV publisher 102 may strategically select which supply channels to include in the portfolio-level optimization based on various factors such as inventory performance characteristics, advertiser demand patterns, or revenue optimization goals. This selection may be dynamic, allowing the TV publisher 102 to adjust the designated supply channels based on market conditions or strategic objectives.

The optimization engine 126 may continuously evaluate the performance of all campaigns within the designated supply channels, making real-time adjustments to placements to maximize yield optimization results for the TV publisher 102. This may involve reassigning inventory allocations between campaigns, adjusting pricing strategies, or modifying placement timing to achieve optimal overall performance across the entire demand and supply portfolio.

In some implementations, the system 100 may support multiple sets of designated supply channels operating simultaneously, each with its own portfolio-level optimization process. This may allow TV publishers 102 to segment their inventory management strategies while still benefiting from the efficiency gains of simultaneous multi-campaign optimization within each segment.

This approach may provide enhanced scalability compared to individual campaign optimization methods, as the computational complexity may grow more efficiently when processing campaigns collectively rather than separately. The portfolio-level optimization may also enable more sophisticated yield management strategies that consider the interdependencies and competitive dynamics between different advertiser campaigns within the designated supply channels.

In addition to performing optimization, the system 100 may provide a forecasting capability which generates predictions of future outcomes based on historical data, current market trends, and input variables such as ad campaign details and inventory availability. This forecasting feature provides the TV publisher 102 with a clear and data-driven projection of potential revenue and inventory utilization (percent sellout) over a defined future period, such as several weeks or months. This enables the TV publisher 102 to make informed decisions about inventory management, pricing strategies, and promotional activities.

The system 100 may implement the forecasting feature in any of a variety of ways. For example, the system 100 may analyze historical data (such as past campaign performance metrics, seasonal viewership patterns, historical pricing trends, previous inventory sell-through rates, advertiser spending behaviors, daypart performance variations, genre-specific engagement statistics, and/or demographic response patterns) to forecast higher viewer engagement and ad demand during specific seasons or events (e.g., holiday seasons, sports events). Based on this, the system 100 may project increased revenue opportunities and suggest optimal pricing strategies to maximize sellout rates during these peak times.

The system 100 may simulate various pricing scenarios to show how changes in price floors or rates could affect revenue and sellout percentages. For example, the system 100 may forecast the impact of pricing adjustments through simulations such as:
Lowering price floors for less popular time slots to project potential increases in sellout rates and the corresponding impact on overall revenue;
Implementing tiered pricing structures across different dayparts to optimize revenue distribution throughout the broadcast day;
Adjusting premium pricing for high-demand events such as sports broadcasts or season premieres to determine maximum revenue potential without reducing sellout rates;
Modeling the effects of seasonal pricing strategies that account for historical viewership patterns during holiday periods, summer months, or special events;
Simulating dynamic price floor adjustments based on inventory availability thresholds, where prices automatically adjust as sellout percentages reach certain levels;
Forecasting revenue impacts of offering volume discounts to advertisers who commit to multiple ad placements or extended campaign durations;
Analyzing the potential effects of competitive pricing adjustments in response to market conditions or competitor pricing strategies.

For publishers looking to plan their strategy for the upcoming quarter or year, the system 100 may aggregate data across multiple variables (such as historical viewership patterns, seasonal advertising trends, advertiser spending behaviors, program performance metrics, demographic engagement statistics, pricing elasticity factors, inventory utilization rates, and/or competitive market positioning) to provide a comprehensive revenue and sellout forecast. This may include predictions on how upcoming programming changes or new ad products might influence market dynamics.

The forecasting feature has a variety of benefits. For example, with accurate forecasts, TV publishers may better plan their inventory allocation, pricing, and promotional strategies to align with expected market conditions. This proactive planning helps in optimizing resource utilization and maximizing revenue. By understanding potential sellout rates, publishers may make informed decisions about which inventory to prioritize or hold back, potentially increasing the overall value of their ad slots. Furthermore, forecasting provides insights into future trends and potential market shifts, allowing publishers to mitigate risks associated with unexpected changes in demand or viewer behavior. This can lead to more stable and predictable revenue streams.

The system 100 may enhance any of the optimization capabilities disclosed herein by incorporating any of a variety of audience-based data. As an example, the system 100 may ingest Cost Per Mille (CPM) bids and audience estimates, broken down by hour. This hourly breakdown enables advertisers to tailor their bids based on anticipated viewer engagement and to optimize their ad spend for maximum impact.

To determine the cost-effectiveness of ad placements, the system 100 may use a formula such as the following:

Unit Rate=CPM×Audience Estimate

This formula calculates the unit rate for ad placements by multiplying the CPM bid by the estimated audience size per hour. This method ensures that pricing is directly correlated with the expected reach of the advertisement, allowing for precise budget allocation and enhanced ROI predictability.

The optimization engine 126 may repeatedly (e.g., continuously) evaluate the effectiveness of ad placements against predefined outcome goals set by the advertiser 114. By integrating CPM and audience data, the system 100 may dynamically adjust placements to maximize both viewer engagement and cost-efficiency, ensuring that each ad reaches its intended audience with optimal timing and pricing.

Such audience-based capabilities may be seamlessly integrated into the existing architecture of the system 100, enhancing its current functionalities without disrupting its core workflows. The system 100's interfaces, both for the publisher 102 and the advertiser 114, may be updated to allow easy input and modification of CPM bids and audience estimates, ensuring a user-friendly experience.

The system 100 may process and analyze performance data collected during the optimization of TV ad campaigns. The 100 may perform such data processing to identify trends and generate valuable performance estimates across various dimensions such as product category, time of day, program genre, and specific programs. These insights may then be packaged and licensed to advertisers, providing them with strategic advantages in planning and executing their advertising campaigns.

For example, the system 100 may collects a wide range of data during the ad campaign optimization process, such as viewer engagement metrics, click-through rates, conversion data, and other relevant performance indicators. The system 100 may use any of a variety of analytics algorithms and/or machine learning techniques to analyze the collected data. For example, machine learning models may be used to predict viewer engagement based on historical data and current campaign inputs.

Embodiments of the present invention may harness the power of artificial intelligence (AI) (e.g., machine learning (ML)) to enhance the optimization of television advertising campaigns. For example, by leveraging the vast amounts of data accumulated from running large numbers (e.g., thousands) of campaigns, the system 100 may use machine learning to refine and improve buy-side campaign inputs, thereby making the optimization process performed by the system 100 both quicker and more effective.

For example, the system 100 may use machine learning algorithms to analyze historical data from a multitude of advertising campaigns to identify patterns and trends that may not otherwise be immediately apparent. Such analysis may include, for example, using any of a variety of metrics, such as viewer engagement rates, conversion rates, and/or the effectiveness of different ad placements across various times and networks. By identifying these patterns, the system 100 may predict which campaign strategies are likely to yield the best outcomes.

For example, the system 100 may use machine learning to adjust bidding strategies (e.g., in real-time) based on the ongoing performance data of live campaigns. This dynamic adjustment ensures that advertisers can respond to market changes instantaneously, optimizing ad placements for the best possible outcomes at any given moment.

The system 100 may use AI (e.g., ML) to analyze historical data and generate intelligent, actionable insights that support decision-making for both the buy-side (advertisers) and sell-side (TV publishers). This capability enhances the strategic effectiveness of advertising campaigns and inventory management by providing data-backed recommendations that are tailored to the specific needs and objectives of each party. For example, the system 100 may use machine learning algorithms such as random forests, gradient boosting, or neural networks to sift through datasets comprising past campaign performances, viewer engagement metrics, pricing models, and/or inventory utilization rates. These datasets may include hourly viewership patterns across different demographics, historical ad response rates by program genre, seasonal fluctuations in audience engagement, and competitive placement performance metrics. The system 100 may analyze such data to identify underlying patterns and correlations that may not be evident through traditional analysis methods.

On the advertiser (buy) side, the system 100 may analyze outcomes from previous campaigns to determine what combinations of content, timing, and audience targeting yielded the highest engagement and conversion rates. For example, AI may reveal that video ads for a particular product perform exceptionally well during evening dayparts on specific networks targeting urban demographics. The system 100 may employ supervised learning techniques to analyze historical campaign data including viewer demographics, ad placement times, creative formats, and resulting conversion metrics to generate predictive models that forecast performance for similar future placements. These models may output specific recommendations such as “placing ads for automotive products between 8-10 PM on sports networks may yield 23% higher engagement rates compared to other dayparts” or “financial service advertisements placed during morning news programs targeting viewers aged 35-54 may generate conversion rates 15% above campaign averages.”

On the sell-side, the system 100 may use machine learning to evaluate historical data related to ad slot pricing and sell-through rates to recommend optimal pricing strategies for TV publishers. For example, if the data indicates that lowering prices for certain time slots significantly increases sell-through rates without a substantial drop in revenue, the system 100 might suggest adjusting the pricing model accordingly. The system 100 may implement reinforcement learning algorithms that analyze pricing elasticity data, historical inventory sell-through rates, seasonal demand patterns, and competitive pricing information to generate dynamic pricing recommendations. These recommendations may include specific outputs such as “increasing price floors by 12% for prime-time slots during sporting events may maximize revenue without significantly reducing sell-through rates” or “implementing a 15% price reduction for late-night inventory on weekdays may increase sell-through rates by approximately 30% while maintaining overall revenue targets.”

The system 100 may use AI (e.g., ML) to forecast trends and/or outcomes based on any of the data disclosed herein, thereby enabling a dynamic and automated approach to pricing that eliminates the need for manual price floors while maximizing yield. This sophisticated forecasting capability allows both TV publishers and advertisers to respond proactively to market changes and optimize their revenue and advertising effectiveness. For example, the system 100 may implement time-series forecasting models such as ARIMA (Autoregressive Integrated Moving Average) or LSTM (Long Short-Term Memory) neural networks to analyze historical data, current market conditions, and/or real-time campaign performance to predict future trends in viewer behavior, ad demand, and/or pricing elasticity. The system 100 may process data including multi-year seasonal viewing patterns, day-of-week audience fluctuations, program-specific engagement metrics, and competitive placement data to generate forecasts such as “viewership for home improvement programming is projected to increase by 18% in the upcoming spring season, suggesting an opportunity to adjust pricing upward for related advertising categories” or “demand for pharmaceutical advertising is predicted to increase by 22% in Q4, indicating potential for inventory allocation adjustments to maximize revenue.”

Traditionally, TV publishers set manual price floors to protect revenue, but these static thresholds can lead to missed opportunities if set too high or revenue loss if set too low. In contrast, the system 100 may use AI (e.g., ML) to eliminate the need for these manual settings by repeatedly (e.g., continuously) calculating and adjusting the optimal price floor (or eliminating the need for price floors) based on comprehensive data analysis. AI may be used to implement trade-off evaluation methods that weigh the benefits of maintaining price floors against the potential yield gains from relaxation, considering factors such as inventory velocity, market demand elasticity, and competitive positioning. For example, one or more machine learning models may be used to analyze historical data to identify patterns where specific degrees of price floor relaxation resulted in optimal yield outcomes, enabling predictive recommendations for future price floor adjustments. The system 100 may employ ensemble learning methods combining multiple algorithms such as decision trees, support vector machines, and neural networks to process real-time market data including current sell-through rates, competitor pricing movements, advertiser bidding patterns, and inventory availability levels. These models may generate dynamic price floor recommendations that update hourly or even more frequently, such as by determining not only whether to relax price floors but also calculating the precise percentage reduction that maximizes yield while minimizing revenue risk. Risk assessment algorithms may be used to evaluate the probability of successful inventory sell-through at various price points, producing outputs such as “current market conditions suggest temporarily reducing price floors by 8% for the next 3 hours in the early afternoon daypart to capitalize on unexpected advertiser demand” or “analysis indicates opportunity to increase minimum pricing by 15% for weekend prime-time slots due to heightened demand for upcoming sports programming.”

AI-driven decision-making processes for price floor relaxation may incorporate multi-layered analysis that evaluates inventory characteristics, market dynamics, and historical performance data simultaneously. Machine learning algorithms may segment inventory into categories based on factors such as daypart performance, audience demographics, program genre, and seasonal demand patterns, then apply different price floor relaxation strategies to each segment. Such techniques may use predictive modeling to forecast the impact of various price floor adjustment scenarios, calculating expected outcomes such as inventory fill rates, revenue per slot, and overall yield improvements. Real-time monitoring systems may track the immediate effects of price floor changes on advertiser behavior, measuring metrics such as bid frequency, campaign activation rates, and budget allocation shifts to determine the effectiveness of relaxation decisions. Embodiments of the present invention may use AI to implement feedback loops that refine the price floor relaxation algorithms based on observed outcomes, building institutional knowledge about which market conditions favor aggressive price floor reductions versus conservative adjustments. One or more machine learning models may identify subtle market signals that indicate optimal timing for price floor relaxation, such as patterns in advertiser spending behavior, seasonal viewing trends, or competitive inventory availability that suggest opportunities for yield optimization through strategic pricing adjustments.

The system 100 may use AI (e.g., ML) to enhance the visualization of data, enabling users to make more informed decisions about ad placements. For example, the system 100 may use AI to create heat maps that visually represent the optimal TV networks, dayparts, and/or hours for ad placement, based on an analysis of historical data and predictive modeling.

Heat maps are an effective visual tool for representing complex data through color-coded systems, making it easier to identify trends and patterns at a glance. In the context of the system 100, AI/ML algorithms may analyze vast amounts of performance data across different metrics such as viewer engagement, conversion rates, and/or cost efficiency. The system 100 may then use this analysis to generate heat maps that highlight the most advantageous times and networks for ad placements. In addition to being valuable individually, such heat maps may be used to compare the performance of different ad strategies, creative content, or campaign types across networks and times.

The system 100 may generate various types of specialized heat maps to provide comprehensive insights for both TV publishers and advertisers. For example, the system 100 may generate revenue opportunity heat maps that visualize potential revenue gains across different dayparts and networks, with color intensity indicating higher revenue potential based on historical performance and current market conditions. The system 100 may also generate demographic engagement heat maps that display viewer engagement patterns across different demographic segments, helping advertisers target specific audience groups more effectively. In some cases, the system 100 may produce conversion rate heat maps that illustrate which time slots and networks historically yield the highest conversion rates for specific product categories or industries.

The system 100 may also generate competitive placement heat maps that visualize where competitors are placing advertisements, helping advertisers identify underutilized opportunities or avoid oversaturated time slots. Additionally, the system 100 may create seasonal performance heat maps that highlight how ad performance varies throughout the year, enabling more strategic planning for seasonal campaigns. In some implementations, the system 100 may generate price elasticity heat maps that show how sensitive different inventory segments are to price changes, helping publishers optimize their pricing strategies.

To generate these heat maps, the system 100 may employ various data processing techniques. For example, the system 100 may use clustering algorithms such as K-means or hierarchical clustering to group similar performance patterns across different time slots and networks. The system 100 may implement dimensionality reduction techniques like Principal Component Analysis (PCA) to identify the most significant factors influencing ad performance. In some cases, the system 100 may utilize gradient boosting algorithms to predict performance metrics for different combinations of networks, dayparts, and ad types, then translate these predictions into color-coded visualizations. The system 100 may also apply time-series analysis methods to identify temporal patterns and trends in performance data, which are then represented through color intensity variations in the heat maps.

The system 100 may enhance these heat maps with interactive features that allow users to filter and drill down into specific data segments. For example, users may be able to adjust time ranges, select specific networks or dayparts, filter by product category, or toggle between different performance metrics. The system 100 may also implement comparative heat map views that allow side-by-side analysis of different campaigns, time periods, or optimization strategies. In some implementations, the system 100 may provide automated insights alongside the heat maps, highlighting notable patterns or anomalies and suggesting potential optimization actions based on the visualized data.

The system 100 may implement real-time heat map integration capabilities that enable dynamic buyer notifications and AI-driven campaign re-optimization during live campaign execution. These capabilities may extend beyond static visualization to provide actionable intelligence that informs advertisers of optimization opportunities as they emerge based on continuously updated heat map analysis.

The system 100 may utilize real-time data processing mechanisms that update heat maps at configurable intervals, such as every 15 minutes, hourly, or based on significant performance threshold changes. As heat maps are updated with new performance data, machine learning algorithms may analyze the changes to identify optimization opportunities that warrant buyer attention. The system 100 may implement automated threshold monitoring that triggers notifications when heat map analysis indicates potential improvements exceeding predefined performance or cost-efficiency thresholds.

When optimization opportunities are identified through heat map analysis, the system 100 may generate automated buyer notifications that translate heat map insights into specific, actionable campaign adjustment recommendations. These notifications may include recommendations such as shifting budget allocation from underperforming dayparts highlighted in red zones of performance heat maps to high-opportunity zones shown in green, adjusting CPO targets for specific networks based on competitive placement heat map analysis, modifying geographic targeting based on regional performance variations displayed in demographic engagement heat maps, or reallocating inventory preferences based on seasonal performance heat map trends that indicate emerging opportunities.

The AI-driven recommendation engine may process multiple heat map data sources simultaneously to generate comprehensive optimization suggestions. For example, the system 100 may correlate revenue opportunity heat maps with competitive placement analysis to recommend strategic timing adjustments that capitalize on competitor-free time slots while maximizing revenue potential. The system 100 may combine conversion rate heat maps with price elasticity analysis to suggest optimal bid adjustments that improve campaign performance while maintaining cost efficiency.

The system 100 may implement sophisticated feedback loops that continuously refine heat map accuracy and recommendation quality based on buyer responses and campaign outcomes. When buyers accept or decline AI-generated recommendations, the system 100 may track the subsequent performance impact to improve future recommendation algorithms. Machine learning models may analyze patterns in successful recommendations to identify characteristics that correlate with positive campaign outcomes, enabling more precise targeting of future optimization suggestions.

Buyer notification systems may be implemented through multiple communication channels, including real-time dashboard alerts, email notifications, mobile push notifications, API callbacks to integrated campaign management systems, and automated reports delivered at specified intervals. The system 100 may enable buyers to configure notification preferences, including threshold levels for triggering alerts, preferred communication channels, and frequency settings for different types of recommendations.

The system 100 may provide buyers with multiple response options for AI-driven recommendations, including immediate acceptance for automatic implementation, scheduled implementation at specified times, partial acceptance with modified parameters, or rejection with feedback for algorithm improvement. When buyers accept recommendations, the system 100 may implement changes automatically while providing confirmation notifications and performance tracking for the adjusted campaigns.

Timing mechanisms within the system 100 may optimize the delivery of recommendations based on campaign urgency, market conditions, and buyer preferences. For example, the system 100 may prioritize immediate notifications for time-sensitive opportunities such as competitor withdrawal from premium inventory, while scheduling less urgent recommendations for regular business hours. The system 100 may implement intelligent batching that groups related recommendations to avoid notification fatigue while ensuring critical opportunities are communicated promptly.

The system 100 may maintain detailed audit trails of all heat map-driven recommendations, buyer responses, and implementation outcomes to support continuous improvement of the AI recommendation algorithms. Performance analytics may track metrics such as recommendation acceptance rates, performance improvements achieved through implemented suggestions, and buyer satisfaction with the recommendation quality and timing. These analytics may inform ongoing refinement of heat map generation algorithms, recommendation logic, and notification delivery mechanisms to enhance the overall effectiveness of the real-time optimization system.

The system 100 may segment the data based on predefined categories, such as time of day (morning, afternoon, evening, late night), day of week (weekday versus weekend), product category (automotive, consumer packaged goods, pharmaceuticals, financial services, retail), program genre (news, sports, drama, comedy, reality), specific programs (individual shows or series), viewer demographics (age groups, gender, income level, education), geographic regions (urban, suburban, rural, specific markets), seasonal periods (holiday seasons, summer months, special events), device types (mobile, desktop, connected TV), and engagement metrics (click-through rates, conversion rates, view completion rates). The system 100 may then perform trend analysis within these segments to identify which factors are most influential in driving campaign success.

Based on the trends and patterns identified, the system 100 may generate performance estimates for various segments. These estimates provide predictions about future campaign performance under similar conditions. For example, the performance estimates may include predicted viewer engagement rates for specific dayparts, expected conversion rates for different product categories across various program genres, anticipated click-through rates based on ad placement timing, projected brand lift metrics for particular demographic segments, estimated cost-per-acquisition values for different networks, forecasted return on ad spend by hour of day, predicted audience retention rates for specific creative formats, expected website traffic increases following ad placements, anticipated social media engagement metrics correlated with TV exposure, and/or projected sales lift estimates for different seasonal periods. The system 100 may generate these performance estimates using historical data analysis, machine learning algorithms, statistical modeling techniques, and/or pattern recognition across multiple campaign variables.

Once the performance estimates are generated, they can be packaged into reports or dashboards and licensed to advertisers. This provides advertisers with actionable insights that they can use to optimize their future campaigns. Advertisers may use the licensed performance estimates to make more informed decisions about where and when to place their ads. For example, if data shows that ads for a particular product category perform well during late-night slots on certain genres of programs, advertisers may strategically plan to increase their ad spend in those areas. By having access to detailed performance estimates, advertisers can tailor their campaigns to maximize engagement and conversion rates, leading to a higher return on investment.

The system 100 may track unit rates paid for advertisements and couple these rates with performance estimates to produce Cost Per Outcome (CPO) trends across various dimensions, such as product category, time of day, program genre, specific programs, viewer demographics, geographic regions, seasonal periods, device types, engagement metrics, and/or day of week. This feature is useful for providing deep insights into the effectiveness and efficiency of ad spend in relation to achieved outcomes, enabling both TV publishers and advertisers to refine their strategies and optimize their investments.

This feature is useful for providing deep insights into the effectiveness and efficiency of ad spend in relation to achieved outcomes, enabling both TV publishers and advertisers to refine their strategies and optimize their investments.

For example, the system 100 may record the unit rates paid for each ad slot across different campaigns. This may include capturing the financial details associated with each ad placement, such as the cost per impression or cost per click, depending on the pricing model used.

In addition to tracking unit rates, the system 100 may also collect performance data for each ad campaign. This data may, for example, include metrics such as viewer engagement rates, conversion rates, and other relevant indicators of campaign success.

The system 100 may correlate the tracked unit rates with the performance data. This analysis helps in understanding how different unit rates correlate with various levels of campaign performance across different times of day, product categories, program genres, and specific programs.

By analyzing the relationship between unit rates and campaign performance, the system 100 may generate trends in CPO. These trends provide insights into the cost-effectiveness of ad placements in achieving desired outcomes, segmented by various categories and timeframes. The system 100 may visualize the insights generated from the CPO trend analysis in reports or dashboards, making them easily accessible and understandable for advertisers. These reports may be customized to focus on specific areas of interest.

Advertisers may use the CPO trends to identify which types of ads, times of day, or content genres offer the best return on investment. This allows them to allocate their budgets more effectively, focusing on high-performing options and reducing spend on less effective ones. Understanding CPO trends helps advertisers and publishers plan their strategies more effectively. For example, if certain genres or programs consistently show favorable CPO trends, they may be prioritized in future advertising plans.

The system 100 may implement AI-driven post-optimization analysis capabilities that systematically evaluate campaign performance, e.g., at the end of each optimization cycle. This analysis may compare actual campaign results against the advertiser's original CPO goals and performance targets to identify performance variance and determine the underlying factors that contributed to over-performance or under-performance relative to buyer expectations.

The AI analysis may examine multiple performance drivers including inventory placement effectiveness, audience engagement patterns, timing optimization results, competitive factors, and market conditions that influenced campaign outcomes. Machine learning algorithms may process this performance data to identify correlations between specific inventory characteristics, placement decisions, and resulting campaign effectiveness, generating insights about which factors most significantly impacted the achievement of advertiser goals.

The system 100 may provide these AI-generated performance insights to the sales side, specifically to TV publishers, through automated reporting mechanisms that explain why campaigns performed as they did. These explanatory insights may include analysis of which inventory segments delivered the strongest performance relative to CPO targets, identification of time slots or dayparts that exceeded or fell short of expected outcomes, and assessment of how market conditions or competitive factors influenced campaign effectiveness.

The AI may generate specific explanations for performance variance, such as identifying that certain dayparts delivered higher-than-expected conversion rates due to favorable audience demographics, or that particular program genres underperformed due to competitive advertising saturation. These insights may help TV publishers understand the relationship between their inventory characteristics and advertiser success metrics, enabling more informed decisions about inventory pricing, allocation strategies, and future optimization approaches.

This systematic feedback mechanism may create a continuous learning loop where TV publishers gain deeper understanding of how their inventory performs for different types of campaigns and advertiser objectives. The AI-generated insights may be presented through dashboards, automated reports, or integrated analytics tools that highlight key performance drivers and provide actionable recommendations for improving future campaign outcomes and inventory monetization strategies.

Although certain embodiments of the present invention are described for use in connection with linear TV, these are merely examples and do not constitute limitations of the present invention. Embodiments of the present invention may be used in connection with connected TV (CTV). Such embodiments incorporate a programmatic guaranteed approach of any of the kinds disclosed herein, in which the best impressions for CTV platforms are automatically selected and aggregated. Such embodiments may, like other embodiments of the present invention, use a CPO metric to calculate multiple unit rates for different ad impressions. Such an approach enables dynamic pricing based on the expected effectiveness of each ad placement, thereby ensuring that advertisers can optimize their budgets for maximum impact. Such embodiments may aggregate the calculated unit rates into a comprehensive budget for CTV ad campaigns. This aggregation will provide a clear overview of total advertising costs, aligned with the expected outcomes and strategic goals of the advertisers.

Embodiments of the present invention have a variety of advantages. For example, embodiments of the present invention target the highest performing inventory for each ad campaign based on the campaign's performance estimates, while simultaneously maximizing revenue for the TV publisher. This dual-focused approach ensures that both advertisers and publishers derive optimal value from their participation in the platform.

The system 100 may implement artificial intelligence capabilities to automatically determine and adjust Cost Per Outcome (CPO) values for advertisers, providing dynamic optimization that responds to market conditions and inventory availability. This AI-driven CPO adjustment feature may address the challenge of balancing inventory acquisition with cost efficiency across multiple TV networks and dayparts simultaneously, while automatically regulating CPO adjustments on behalf of buyers to achieve specific media goals.

The optimization engine 126 may utilize one or more machine learning algorithms to analyze historical campaign performance data, current market dynamics, and/or advertiser-specific goals to recommend and implement optimal CPO adjustments. The optimization engine 126 may process data including previous CPO settings and their corresponding inventory clearance rates, competitive pricing pressures across different networks and time slots, advertiser campaign requirements 122, performance outcomes from similar campaigns, seasonal or temporal patterns in inventory availability 110 and pricing data 112, and/or budget allocation patterns across different network-daypart combinations.

The system 100 may implement automated CPO adjustment mechanisms that operate on the principle that CPO serves as the primary lever for influencing inventory allocation and pricing dynamics. The artificial intelligence may make periodic CPO changes segmented by TV network and by daypart, enabling granular control over pricing strategies that align with three media objectives: performance achievement relative to campaign goals, inventory clearance rates that ensure adequate ad placement volume, and/or budget allocation efficiency that maximizes return on advertising spend while respecting budget constraints.

When advertisers 114 increase their CPO values, the system 100 may enable the advertisers 114 to compete more effectively for premium inventory by offering higher rates, potentially resulting in increased inventory clearance and access to more desirable ad slots. Conversely, when advertisers 114 reduce their CPO values, the system 100 may test whether the same inventory levels can be obtained at lower costs, optimizing budget efficiency while monitoring for any reduction in inventory availability 110. The artificial intelligence may generate network-specific and daypart-specific CPO adjustments based on individual performance characteristics and competitive landscapes, rather than applying uniform adjustments across all inventory segments.

The artificial intelligence may repeatedly (e.g., continuously) monitor the relationship between CPO adjustments and inventory outcomes, learning from each optimization cycle to refine future recommendations. Machine learning models may analyze patterns such as the correlation between CPO increases and inventory clearance improvements, the threshold points where CPO reductions begin to impact inventory acquisition, optimal CPO ranges for different dayparts and networks based on historical performance, and/or competitive dynamics that influence the effectiveness of different CPO strategies.

The system 100 may implement automated CPO regulation mechanisms that operate on configurable time intervals, such as daily, weekly, or based on performance threshold triggers. The artificial intelligence may repeatedly (e.g., continuously) evaluate whether current CPO settings are achieving desired outcomes across the three-dimensional optimization framework of performance, clearances, and/or budget allocation. One or more machine learning models may identify when CPO adjustments are needed to better align campaign results with advertiser media goals, processing multi-dimensional data arrays that correlate CPO values with performance outcomes, clearance success rates, and/or budget utilization efficiency across different network-daypart segments.

The AI-driven CPO optimization may incorporate predictive analytics that anticipate market conditions and inventory availability trends. One or more machine learning algorithms may forecast periods of increased competition or inventory scarcity, automatically suggesting proactive CPO adjustments to maintain desired inventory levels. Similarly, the artificial intelligence may identify opportunities to reduce CPO values during periods of lower competition or higher inventory availability 110, optimizing cost efficiency without sacrificing campaign objectives. This analysis may enable the system 100 to identify optimal CPO ranges for each network-daypart combination that maximize the probability of achieving all three media objectives simultaneously.

The system 100 may implement one or more feedback loops that repeatedly (e.g., continuously) evaluate the effectiveness of AI-generated CPO recommendations. Performance tracking mechanisms may monitor metrics such as inventory clearance rates following CPO adjustments, cost efficiency improvements achieved through optimization, campaign performance outcomes relative to advertiser goals, and/or advertiser satisfaction with automated versus manual CPO management approaches. The automated CPO adjustment capability may address the complexity of managing budget constraints across multiple networks and dayparts while maintaining performance standards and clearance targets.

The artificial intelligence may learn from advertiser-specific preferences and constraints, developing customized optimization strategies that align with individual campaign requirements 122 and risk tolerances. Machine learning models may incorporate factors such as advertiser budget flexibility, inventory priority preferences, performance target hierarchies, and/or acceptable trade-offs between cost and inventory access to generate personalized CPO adjustment recommendations. The artificial intelligence may redistribute budget allocations through strategic CPO adjustments, potentially increasing CPO values for high-performing network-daypart combinations while reducing them for segments that are over-delivering on clearances relative to performance outcomes.

The system 100 may provide transparency and control mechanisms that enable advertisers 114 to understand and influence the AI-driven CPO optimization process. User interfaces may display explanations of recommended CPO adjustments, including the data factors and reasoning behind each suggestion. Advertisers 114 may retain the ability to accept, modify, and/or reject AI recommendations, with the system 100 learning from these decisions to improve future optimization accuracy.

The automated CPO adjustment capability may reduce the operational burden on advertising agencies and media buyers, who traditionally rely on trial-and-error approaches to determine optimal CPO values. The artificial intelligence may process market data and performance history to make informed adjustments that would be impractical for human operators to calculate manually, particularly when managing campaigns across numerous networks and dayparts simultaneously. This granular approach may enable more precise optimization that maximizes inventory acquisition efficiency while minimizing unnecessary overspend across the complex matrix of network-daypart combinations that characterize modern television advertising campaigns.

The AI-driven CPO optimization may evaluate how much higher an ad would need to be priced in order to have cleared versus the other demand on the platform. The optimization engine 126 may analyze historical clearance data to identify pricing thresholds at which specific ad inventory successfully cleared in previous optimization cycles. By comparing the CPO values that resulted in successful ad placements against those that did not clear, the system 100 may determine the minimum CPO increase needed to secure desired inventory. This analysis may be performed at granular levels, examining clearance patterns by network, daypart, program genre, and/or specific time slots to generate precise CPO adjustment recommendations tailored to each inventory segment.

According to an aspect of the present disclosure, a computer-implemented method for optimizing television advertising inventory is provided. The method comprises receiving, by a computer system, input data from a television (TV) publisher, the input data including data representing available TV ad inventory and pricing data associated with the available TV ad inventory. The method comprises receiving, by the computer system, input data from an advertiser, the input data including performance estimates for advertising campaigns, Cost Per Outcome (CPO) goals, campaign requirements, flight dates, and placement parameters. The method comprises optimizing, by the computer system, placement of the advertising campaigns within the available TV ad inventory based on the input data from the TV publisher and the input data from the advertiser, using a neutral optimization engine that simultaneously balances objectives of maximizing revenue for the TV publisher and minimizing deviations from the CPO goals of the advertiser.

According to other aspects of the present disclosure, the method may include one or more of the following features. The input data from the TV publisher may further comprise price minimum data for the available TV ad inventory, wherein the price minimum data specifies lowest acceptable prices for ad slots on an hourly basis. The optimizing may comprise applying the price minimum data to constrain ad placements, such that ads are only placed in time slots where calculated hourly unit rates meet or exceed the specified price minimums. The method may further comprise setting price minimums for specific ad campaigns based on input from the TV publisher, and the optimizing may apply the campaign-specific price minimums during the placement of the respective advertising campaigns.

The input data from the TV publisher may further comprise fee structure data specifying a percentage of passthrough dollars to be charged to the TV publisher for use of the computer system, wherein passthrough dollars comprise revenue that flows through the computer system from advertisers to the TV publisher for ad inventory sold. The optimizing may comprise calculating fees based on the specified percentage of passthrough dollars generated from the optimized ad placements.

The method may further comprise receiving, by the computer system, throttle control input from the TV publisher, and adjusting, by the computer system, a rate of inventory data flow within the data representing available TV ad inventory based on the throttle control input. The optimizing may be performed on different portions of the data representing available TV ad inventory as such portions are received over time according to the adjusted rate of inventory data flow.

The input data from the TV publisher may further comprise configuration data specifying a future time period for optimization. The optimizing may comprise optimizing placement of the advertising campaigns within the available TV ad inventory solely for the specified future time period.

The optimizing may comprise maintaining confidentiality of the CPO goals from the TV publisher during the optimizing. Maintaining the confidentiality of the CPO goals from the TV publisher may comprise storing the CPO goals in a secure portion of the computer system that is inaccessible to the TV publisher.

The method may further comprise receiving, by the computer system, a designation from the advertiser for non-preemptible Direct Response (DR) ad placement, automatically categorizing, by the computer system, an ad placement associated with the designation as non-preemptible DR, applying, by the computer system, a higher price floor to the non-preemptible DR ad placement compared to other ad placements, and prioritizing, by the computer system, the placement of the non-preemptible DR ad within the optimizing to ensure guaranteed visibility.

The performance estimates may comprise performance estimates for each hour within sales dayparts, and the calculated hourly unit rates may align with hourly breakouts of the sales dayparts in the input data received from the TV publisher. The optimizing may comprise calculating hourly unit rates using a formula of CPO multiplied by performance estimate. The optimizing may comprise dynamically adjusting the calculated hourly unit rates in real-time based on ongoing performance data of live advertising campaigns, and updating ad placements based on the dynamically adjusted hourly unit rates to improve campaign effectiveness and publisher revenue.

The optimizing may comprise calculating unit rates for ad placements using a formula of Cost Per Mille (CPM) multiplied by audience estimate. The optimizing may further comprise dynamically adjusting the calculated unit rates in real-time based on ongoing audience data and performance metrics of live advertising campaigns, and updating ad placements based on the dynamically adjusted unit rates to improve campaign reach and publisher revenue.

The optimizing may comprise calculating hourly unit rates for ad placements across multiple TV networks using a single CPO goal provided by the advertiser. The optimizing may further comprise optimizing ad placements across the multiple TV networks simultaneously based on the calculated hourly unit rates.

The optimizing may comprise receiving, by the computer system, fee data specifying a percentage of passthrough dollars to be charged, and implementing, by the computer system, a waterfalling method that maximizes revenue from each separate ad campaign and optimizes for inventory yield. The waterfalling method may comprise evaluating rates advertisers are willing to pay for each hour, identifying the highest rate offered by any advertiser for each hour, allocating available inventory to campaigns offering the highest rates for each hour, sequentially filling remaining inventory from highest to lowest rates, and calculating fees based on the specified percentage of passthrough dollars generated from the allocated inventory.

The optimizing may comprise analyzing, by the computer system, the entire available TV ad inventory and all active advertising campaigns simultaneously to understand demand landscape across all campaigns, dynamically relaxing or eliminating price floors for different segments of the available TV ad inventory based on real-time demand analysis and predictive analytics, maximizing total yield from the available TV ad inventory by making strategic decisions about which price floors to adjust and by how much, wherein the strategic decisions prioritize overall revenue generation across all campaigns rather than individual campaign optimization, and continuously monitoring performance and adjusting the relaxing or eliminating of price floors to ensure optimal revenue generation across all advertising campaigns.

The optimizing may comprise implementing a dual-phase optimization approach. A first phase may comprise maximizing revenue from individual advertising campaigns by prioritizing campaigns based on potential revenue contribution, allocating most desirable ad slots to highest-paying campaigns, and monitoring performance and expenditure of the advertising campaigns. A second phase may comprise identifying advertising campaigns with remaining unspent budgets after the first phase, adjusting price floors for the advertising campaigns with unspent budgets by lowering the price floors to make remaining inventory more attractive and accessible, re-allocating inventory that was not initially used or was underutilized to the advertising campaigns with unspent budgets, and maximizing overall yield from additional allocations while encouraging advertisers to utilize their full budgets.

The method may further comprise analyzing, by the computer system using at least one machine learning algorithm, historical data from multiple advertising campaigns to identify a pattern, generating, by the computer system, a prediction of a future outcomes based on the identified pattern, current market conditions, the input data from the TV publisher, and the input data from the advertiser, and adjusting, by the computer system, the optimization of ad placements based on the generated prediction and ongoing performance data of live advertising campaigns.

The method may further comprise generating, by the computer system, heat maps that visually represent optimal TV networks, dayparts, and hours for ad placement based on analysis of historical performance data and predictive modeling, displaying, by the computer system, the generated heat maps through a user interface to assist in decision-making for ad placements, and incorporating, by the computer system, insights derived from the heat maps into the optimization to refine ad placement strategies across different networks and time slots.

The method may further comprise automatically determining, by the computer system using artificial intelligence algorithms, optimal CPO adjustments for the advertiser based on analysis of historical campaign performance data, current market dynamics, and advertiser-specific goals. The computer system may process data including previous CPO settings and corresponding inventory clearance rates, competitive pricing pressures across different networks and time slots, performance outcomes from similar campaigns, and seasonal patterns in inventory availability to generate CPO adjustment recommendations.

The method may include implementing automated CPO adjustment mechanisms that operate on configurable time intervals, wherein the computer system periodically evaluates whether current CPO settings achieve desired outcomes across performance achievement, inventory clearance rates, and budget allocation efficiency. The artificial intelligence may make periodic CPO changes segmented by TV network and by daypart, enabling granular control over pricing strategies that align with the three media objectives.

The method may comprise continuously monitoring, by the computer system, relationships between CPO adjustments and inventory outcomes, wherein machine learning models analyze patterns including correlations between CPO increases and inventory clearance improvements, threshold points where CPO reductions impact inventory acquisition, and optimal CPO ranges for different dayparts and networks based on historical performance data.

The method may further include incorporating predictive analytics that anticipate market conditions and inventory availability trends, wherein machine learning algorithms forecast periods of increased competition or inventory scarcity and automatically suggest proactive CPO adjustments to maintain desired inventory levels. The computer system may identify opportunities to reduce CPO values during periods of lower competition or higher inventory availability, optimizing cost efficiency without sacrificing campaign objectives.

The method may comprise implementing feedback loops that continuously evaluate effectiveness of AI-generated CPO recommendations, wherein performance tracking mechanisms monitor metrics including inventory clearance rates following CPO adjustments, cost efficiency improvements achieved through optimization, and campaign performance outcomes relative to advertiser goals. The computer system may learn from advertiser-specific preferences and constraints, developing customized optimization strategies that align with individual campaign requirements and risk tolerances.

More specifically, the system 100 uses performance estimates provided by advertisers, which may include data on expected viewer engagement, conversion rates, and other key performance indicators specific to each campaign. These estimates help the system 100 to identify which inventory segments are likely to yield the best results for a particular campaign. By aligning ad placements with inventory that has historically shown high performance for similar campaigns or target demographics, the system 100 ensures that ads are placed where they are most likely to succeed. This targeted placement approach increases the likelihood of achieving the desired outcomes, such as higher engagement rates or better conversion metrics.

On the publisher's side, the system 100's ability to target the highest performing inventory allows TV publishers to price their inventory more effectively. Knowing which inventory is most desirable for certain types of campaigns, publishers can set premium prices for high-performing slots, thus maximizing their revenue potential. By ensuring that high-performing inventory is utilized for the most suitable campaigns, the system 100 helps publishers reduce the occurrence of unsold ad slots and optimize the overall yield from their available inventory. This efficient management of inventory not only boosts revenue but also enhances the publisher's market reputation for delivering value to advertisers.

Advertisers benefit from the system 100 by having their campaigns placed in inventory that is best suited to meet their performance goals. This targeted approach helps in maximizing the impact of their advertising spend. With ads being placed in high-performing inventory, advertisers are likely to see a better return on investment, as their ads reach the right audience at the right time and in the right context.

Publishers benefit from the system 100's ability to maximize revenue through strategic pricing and inventory allocation. By selling high-performing inventory at optimal prices, publishers can significantly increase their advertising revenue.

Furthermore, the system 100's effectiveness in meeting both the performance needs of advertisers and the revenue goals of publishers fosters stronger, more productive relationships between the two parties. This can lead to increased loyalty and longer-term engagements.

Embodiments of the present invention also address a variety of failings and drawbacks of previous ad placement systems. For example, prior art systems in the performance marketing industry have exhibited several significant shortcomings that have limited their effectiveness and efficiency, particularly in the context of TV advertising. These failings primarily revolve around the lack of integrated capabilities that serve both the buyers (advertisers and agencies) and sellers (TV publishers) equitably, the underutilization of critical data for optimization, and the absence of advanced technological tools for forecasting and real-time adjustments. Embodiments of the present invention address these failings through a series of innovative features and functionalities.

For example, traditional systems have not been designed to benefit both buyers and sellers in the performance marketing space. This often results in one-sided advantages, where either the buyer or the seller may feel disadvantaged. Additionally, critical data such as performance estimates, inventory levels, and price floors have historically been siloed, with each side guarding its data to maintain competitive leverage. This lack of transparency and shared goals has hindered the potential for maximizing outcomes for both parties.

Prior systems have not effectively leveraged advertiser performance estimates and CPOs in a way that benefits TV publishers. This data, crucial for optimizing ad placements and pricing strategies, has typically been inaccessible to publishers, preventing them from aligning their inventory offerings with the advertisers'performance goals and budgetary constraints.

Traditional advertising systems have lacked sophisticated AI-driven tools that can dynamically adjust inventory management and pricing strategies based on real-time data and predictive analytics. Furthermore, the absence of accurate and fast forecasting tools has made it difficult for both publishers and advertisers to plan and adjust their strategies proactively.

Embodiments of the present invention address these failings in a variety of ways. For example, embodiments of the present invention are uniquely designed to benefit both buyers and sellers by maintaining a neutral stance that respects the confidentiality of data while optimizing outcomes for both parties. It uses a transparent yet secure method to handle data, ensuring that neither side has undue advantage, thus fostering a trust-based environment.

Unlike prior systems, embodiments of the present invention integrate advertisers'performance estimates and CPOs into the optimization process. This allows TV publishers to understand better and anticipate the value and effectiveness of their inventory for specific campaigns, enabling them to set price minimums and manage inventory more effectively to maximize yield.

Furthermore, embodiments of the present invention leverage advanced AI technologies to dynamically adjust inventory allocations and pricing in real-time, based on a comprehensive analysis of ongoing campaign performance, advertiser inputs, and market conditions. Additionally, embodiments of the present invention include a sophisticated forecasting tool that provides fast, accurate predictions about campaign outcomes, inventory sell-out rates, and revenue potentials. This capability allows both publishers and advertisers to make more informed decisions and adjust their strategies promptly.

Embodiments of the present invention also offer the capability to send accurate pre-logs to agencies and advertisers, providing them with detailed previews of scheduled ad placements. This feature enhances planning accuracy and campaign alignment.

More generally, embodiments of the present invention address a significant asymmetry issue prevalent in the performance marketing industry, in which there is a disconnect between TV publishers and advertisers regarding access to crucial data. This asymmetry hinders optimal ad placement and revenue maximization due to the lack of shared information about ad performance predictions and available inventory. In particular, TV publishers traditionally do not have access to the performance data that advertisers accumulate. Advertisers use this data to model and predict where their ads will perform best, but without insights into daily inventory availability from publishers, they cannot optimally place their ads. Conversely, TV publishers manage their inventory without detailed knowledge of how various ads might perform at different times, which can lead to suboptimal revenue outcomes.

Embodiments of the present invention effectively resolve this asymmetry by creating a system in which advertisers input their performance estimates and Cost Per Outcome (CPO) targets into the system. These estimates are based on historical data and predictive modeling, providing a forecast of how ads are expected to perform in various contexts. Furthermore, TV publishers input data about the inventory available each day. This includes detailed information on the time slots available, the type of inventory, and any other relevant characteristics that could influence ad placement decisions.

By ingesting this information from both sides, embodiments of the present invention allow for a more informed and dynamic optimization process. In particular, the system enables TV publishers to maximize revenue by more effectively matching their inventory with advertiser demands, even without knowing the specific performance metrics of the ads. The system uses the provided data to place ads in slots where they are likely to perform well, based on the advertisers' performance estimates. At the same time, advertisers can achieve lower CPOs by having their ads placed in high-performing locations that align with their targets. For example, CPO reductions of 10% or more are feasible using embodiments of the present invention. This is accomplished without direct knowledge of the specific inventory details or the extent of inventory available, preserving the confidentiality of the publishers'proprietary information.

This approach addresses the asymmetry problem by combining proprietary information from both buyers and sellers in a way that benefits both parties without compromising the confidentiality of their data. No previous system in the linear or CTV advertising markets has effectively bridged this gap between TV publishers and advertisers, making embodiments of the present invention a pioneering solution in the performance marketing industry.

Furthermore, embodiments of the present invention enable advertisers and agencies to re-optimize or renegotiate pricing and adjust budget allocations across all deals frequently, e.g., daily. This feature is particularly advantageous as it automates and streamlines processes that would traditionally require substantial manpower and resources—resources that most advertisers cannot feasibly dedicate on a daily or even weekly basis. Such daily re-optimization ensures that advertisers can continuously fine-tune their ad placements and spending to maximize return on investment and adapt swiftly to changing market dynamics.

The ability to renegotiate pricing daily is a significant departure from traditional advertising methods, where such negotiations would typically be locked in for longer periods due to the complexity and resource demands of manual renegotiation. By automating this process, embodiments of the present invention not only saves significant time and labor but also enhances the agility and effectiveness of advertising campaigns.

Another benefit of embodiments of the present invention is that they significantly enhances operational efficiencies in the management and sale of advertising across multiple TV networks within the same organization. Traditionally, the task of selling advertising space required a dedicated team of one or two sellers per network, which could lead to increased labor costs and potential inefficiencies due to the fragmented approach to sales management.

In contrast, embodiments of the present invention streamline this process by enabling a single person to handle the advertising sales for multiple TV networks. This consolidation is made possible through the system 100's advanced automation and integration capabilities, which provide a unified platform for managing ad sales across various networks. By centralizing the sales process, the system 100 reduces the need for a large sales force, thereby cutting down on labor costs and simplifying the management structure.

In addition, this capability not only reduces operational overhead but also improves consistency and coordination in sales strategies across different networks. With one person overseeing multiple networks, it becomes easier to implement cohesive advertising strategies, optimize inventory use, and respond more agilely to market demands. The system 100's comprehensive analytics and reporting tools support this centralized approach by providing real-time data and insights that help the seller make informed decisions quickly and efficiently.

Embodiments of the present invention may be used to manage a single advertising campaign across multiple TV networks simultaneously, targeting the highest performing inventory. Traditionally, executing such a campaign would require negotiating different rates for each TV network individually, a process that is not only time-consuming but also prone to inefficiencies and increased costs.

In contrast, embodiments of the present invention significantly improve this process by leveraging a unified approach where the optimization of ad placements is driven by a single Cost Per Outcome (CPO) goal. This CPO goal serves as the basis for calculating unit rates, which are then applied uniformly across various sales channels. This methodology allows a TV buyer or advertising agency to control multiple price points across different networks with just one input of CPO, streamlining the campaign management process significantly.

Moreover, embodiments of the present invention eliminate the need for multiple person-to-person negotiations, which are standard in the industry. By setting different CPO targets for each TV network within the same campaign framework, embodiments of the present invention may automatically adjust the pricing and placement strategies accordingly, without the need for direct negotiation. This not only saves time but also ensures that the campaign is optimized for cost-efficiency and performance, leveraging the best available inventory across networks.

Furthermore, a significant limitation of the prior art in television advertising is the inability of agencies to efficiently place ads in the highest performing locations within broad rotations across multiple networks. Agencies often face challenges in securing desired ad placements due to uncertain inventory availability and the cumbersome need to negotiate and renegotiate rates, which lacks both efficiency and speed.

Embodiments of the present invention address these challenges by introducing a sophisticated optimization system that enables streamlined ad buying across a large number of (e.g., 50 or more) TV networks with unprecedented ease. This system may leverage real-time data and advanced algorithms to dynamically allocate ad inventory, ensuring that ads are placed in the most effective slots available. By integrating a centralized control mechanism, embodiments of the present invention enable a single user to manage ad placements across a vast network landscape. This is achieved without the traditional need for constant negotiation, as the system automatically adjusts pricing and placement based on predefined Cost Per Outcome (CPO)/CPM goals and performance estimates. This not only ensures optimal use of available inventory but also significantly reduces the operational burden on agencies, allowing them to focus on strategic decision-making rather than administrative tasks.

In conclusion, by addressing the critical failings of prior art systems, embodiments of the present invention not only enhance the operational efficiency and strategic effectiveness of TV advertising but also foster a more collaborative and transparent ecosystem. This holistic approach ensures that both TV publishers and advertisers can achieve their respective goals while maximizing the overall market potential.

For example, embodiments of the system 100 may use complex algorithms to dynamically adjust ad placements and pricing in real-time based on continuously changing data inputs such as viewer behavior, market demand, and performance metrics. This process involves the analysis of large datasets at speeds and accuracies that are impossible to achieve manually or mentally.

As another example, the forecasting capabilities of system 100 are based on artificial intelligence that can predict market trends, campaign performance, and inventory sell-out rates with a high degree of accuracy. These predictions are based on the analysis of historical data patterns, current market inputs, and probabilistic modeling, which are computationally intensive and require the processing power of computer systems.

As yet another example, the optimization engine 126 within system 100 may make thousands of automated decisions per second to optimize ad placements and pricing strategies. These decisions are based on complex decision-making models that consider multiple variables and constraints simultaneously, a task that is unfeasible without the aid of computer processors.

As yet another example, the optimization engine 126 within system 100 may make thousands of automated decisions per second to optimize ad placements and pricing strategies. These decisions are based on complex decision-making models that consider multiple variables and constraints simultaneously, a task that is unfeasible without the aid of computer processors.

The system 100 may implement novel data processing architectures that improve upon conventional advertising platforms by creating a neutral optimization framework that processes confidential data from multiple parties without exposing sensitive information between them. This technical approach may require specialized data segregation techniques, encrypted processing methods, and secure computation algorithms that represent improvements over existing computer-based advertising systems.

The optimization engine 126 may utilize advanced multi-objective optimization algorithms that simultaneously balance competing goals of revenue maximization for publishers and cost minimization for advertisers. These algorithms may implement sophisticated mathematical models that process multiple data streams in parallel, requiring specialized computer architectures and processing techniques that exceed the capabilities of conventional advertising systems.

The system 100 may implement real-time throttling mechanisms that dynamically control inventory data flow rates based on market conditions and publisher preferences. Such throttling requires continuous monitoring of data transmission rates, automated adjustment of bandwidth allocation, and real-time synchronization across multiple network connections, which are inherently computer-based operations that cannot be replicated through manual processes.

The forecasting capabilities may utilize ensemble machine learning models that combine multiple predictive algorithms, such as time-series analysis, neural networks, and statistical modeling, to generate accurate predictions. These models may process thousands of variables simultaneously and update predictions in real-time as new data becomes available, requiring computational resources and processing speeds that are fundamentally beyond human capabilities.

The invention may solve specific technical problems in the television advertising industry by automating complex negotiations and optimizations that traditionally required extensive manual coordination between multiple parties. The system 100 may eliminate inefficiencies in inventory allocation by processing large volumes of advertising data and automatically matching advertiser requirements with publisher inventory in ways that optimize outcomes for both parties.

The system 100 may implement automated price floor adjustments and dynamic inventory management that responds to market conditions faster than human operators could process the relevant information. This automation may prevent revenue losses that occur when manual processes cannot adapt quickly enough to changing market dynamics.

The optimization process may require simultaneous evaluation of thousands of potential ad placement combinations across multiple networks, time slots, and advertiser campaigns. Each evaluation may involve complex mathematical calculations considering performance estimates, cost per outcome goals, audience demographics, and pricing constraints. The computational complexity of evaluating all possible combinations and selecting optimal placements may grow exponentially with the number of variables, making manual calculation impractical or impossible.

The system 100 may process and correlate data from multiple sources in real-time, including viewer behavior analytics, market demand indicators, competitive pricing information, and campaign performance metrics. The volume and velocity of this data processing may exceed human cognitive capabilities, particularly when decisions must be made within milliseconds to capitalize on advertising opportunities.

These exemplary features clearly demonstrate that the optimization system 100 is necessarily rooted in computer technology, relying on its capabilities to perform tasks that are beyond human ability in terms of speed, accuracy, and complexity.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention, such as the system 100, include several features that are necessarily rooted in computer technology and are beyond the scope of manual or mental execution due to their complexity, speed requirements, and/or data processing capabilities. These features leverage advanced algorithms, real-time data processing, and machine learning techniques that necessitate the use of sophisticated computer systems.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

Unless expressly and specifically stated otherwise in this specification, the omission from this specification of any subject matter, terminology, embodiments, examples, features, elements, steps, or other content that was disclosed in any application to which this application claims priority (including, but not limited to, any provisional application) is not intended to disclaim, surrender, or narrow the scope of any claim term herein. Such omissions are made solely for purposes of brevity, clarity, organization, or drafting preference and shall not be construed as evidencing any intent by the applicant to limit, restrict, or abandon any aspect of the claimed invention or to exclude any interpretation that would otherwise be available based on the incorporated subject matter. The applicant specifically reserves the right to claim the full scope of any invention disclosed in any application incorporated herein by reference or otherwise whose priority or benefit is claimed, whether or not such invention is explicitly redescribed in this specification. Any construction of claim terms should consider the full scope of disclosure available in this specification together with all incorporated applications, and no negative inference should be drawn from any omission of previously disclosed subject matter unless such limitation is expressly and unambiguously set forth in this specification.

What is claimed is:

1. A method performed by at least one computer processor executing computer program instructions stored on at least one non-transitory computer-readable medium, the method comprising:
(A) receiving, by a computer system, input data from a television (TV) publisher, the input data including:
data representing available TV ad inventory; and
pricing data associated with the available TV ad inventory;
(B) receiving, by the computer system, input data from an advertiser, the input data including:
performance estimates for advertising campaigns;
Cost Per Outcome (CPO) goals;
campaign requirements;
flight dates; and
placement parameters;
(C) optimizing, by the computer system, placement of the advertising campaigns within the available TV ad inventory based on the input data from the TV publisher and the input data from the advertiser, using a neutral optimization engine that simultaneously balances objectives of maximizing revenue for the TV publisher and minimizing deviations from the CPO goals of the advertiser.

2. The method of claim 1, wherein the input data from the TV publisher further comprises:
price minimum data for the available TV ad inventory, wherein the price minimum data specifies lowest acceptable prices for ad slots on an hourly basis; and
wherein the optimizing in step (C) comprises:
applying the price minimum data to constrain ad placements, such that ads are only placed in time slots where calculated hourly unit rates meet or exceed the specified price minimums.

3. The method of claim 1, wherein the optimizing comprises maintaining confidentiality of the CPO goals from the TV publisher during the optimizing.

4. The method of claim 1, further comprising:
receiving, by the computer system, a designation from the advertiser for non-preemptible Direct Response (DR) ad placement;
automatically categorizing, by the computer system, an ad placement associated with the designation as non-preemptible DR;
applying, by the computer system, a higher price floor to the non-preemptible DR ad placement compared to other ad placements; and
prioritizing, by the computer system, the placement of the non-preemptible DR ad within the optimizing to ensure guaranteed visibility.

5. The method of claim 1, wherein the optimizing comprises:
calculating hourly unit rates using a formula of CPO multiplied by performance estimate.

6. The method of claim 5, wherein the optimizing comprises:
dynamically adjusting the calculated hourly unit rates in real-time based on ongoing performance data of live advertising campaigns; and
updating ad placements based on the dynamically adjusted hourly unit rates to improve campaign effectiveness and publisher revenue.

7. The method of claim 1, wherein the optimizing comprises:
calculating unit rates for ad placements using a formula of Cost Per Mille (CPM) multiplied by audience estimate.

8. The method of claim 7, wherein the optimizing further comprises:
dynamically adjusting the calculated unit rates in real-time based on ongoing audience data and performance metrics of live advertising campaigns; and
updating ad placements based on the dynamically adjusted unit rates to improve campaign reach and publisher revenue.

9. The method of claim 1, wherein the optimizing comprises:
calculating hourly unit rates for ad placements across multiple TV networks using a single CPO goal provided by the advertiser; and
optimizing ad placements across the multiple TV networks simultaneously based on the calculated hourly unit rates.

10. The method of claim 1, wherein the optimizing comprises:
receiving, by the computer system, fee data specifying a percentage of passthrough dollars to be charged;
implementing, by the computer system, a waterfalling method that maximizes revenue from each separate ad campaign and optimizes for inventory yield, wherein the waterfalling method comprises:
evaluating rates advertisers are willing to pay for each hour;
identifying the highest rate offered by any advertiser for each hour;
allocating available inventory to campaigns offering the highest rates for each hour;
sequentially filling remaining inventory from highest to lowest rates; and
calculating fees based on the specified percentage of passthrough dollars generated from the allocated inventory.

11. The method of claim 1, wherein the optimizing comprises:
analyzing, by the computer system, the entire available TV ad inventory and all active advertising campaigns simultaneously to understand demand landscape across all campaigns;
dynamically relaxing or eliminating price floors for different segments of the available TV ad inventory based on real-time demand analysis and predictive analytics; and
maximizing total yield from the available TV ad inventory by making strategic decisions about which price floors to adjust and by how much, wherein the strategic decisions prioritize overall revenue generation across all campaigns rather than individual campaign optimization.

12. The method of claim 1, further comprising:
analyzing, by the computer system using at least one machine learning algorithm, historical data from multiple advertising campaigns to identify a pattern;
generating, by the computer system, a prediction of a future outcomes based on the identified pattern, current market conditions, the input data from the TV publisher, and the input data from the advertiser; and
adjusting, by the computer system, the optimization of ad placements based on the generated prediction and ongoing performance data of live advertising campaigns.

13. The method of claim 1, further comprising:
generating, by the computer system, heat maps that visually represent optimal TV networks, dayparts, and hours for ad placement based on analysis of historical performance data and predictive modeling;
displaying, by the computer system, the generated heat maps through a user interface to assist in decision-making for ad placements; and
incorporating, by the computer system, insights derived from the heat maps into the optimization to refine ad placement strategies across different networks and time slots.

14. A system comprising at least one non-transitory computer-readable medium having computer program instructions stored thereon, the computer program instructions being executable by at least one computer processor to perform a method, the method comprising:
(A) receiving, by a computer system, input data from a television (TV) publisher, the input data including:
data representing available TV ad inventory; and
pricing data associated with the available TV ad inventory;
(B) receiving, by the computer system, input data from an advertiser, the input data including:
performance estimates for advertising campaigns;
Cost Per Outcome (CPO) goals;
campaign requirements;
flight dates; and
placement parameters;
(C) optimizing, by the computer system, placement of the advertising campaigns within the available TV ad inventory based on the input data from the TV publisher and the input data from the advertiser, using a neutral optimization engine that simultaneously balances objectives of maximizing revenue for the TV publisher and minimizing deviations from the CPO goals of the advertiser.

15. The system of claim 14, wherein the input data from the TV publisher further comprises:
price minimum data for the available TV ad inventory, wherein the price minimum data specifies lowest acceptable prices for ad slots on an hourly basis; and
wherein the optimizing in step (C) comprises:
applying the price minimum data to constrain ad placements, such that ads are only placed in time slots where calculated hourly unit rates meet or exceed the specified price minimums.

16. The system of claim 14, wherein the optimizing comprises:
calculating hourly unit rates using a formula of CPO multiplied by performance estimate.

17. The system of claim 16, wherein the optimizing comprises:
dynamically adjusting the calculated hourly unit rates in real-time based on ongoing performance data of live advertising campaigns; and
updating ad placements based on the dynamically adjusted hourly unit rates to improve campaign effectiveness and publisher revenue.

18. The system of claim 14, wherein the optimizing comprises:
calculating unit rates for ad placements using a formula of Cost Per Mille (CPM) multiplied by audience estimate.

19. The system of claim 18, wherein the optimizing further comprises:
dynamically adjusting the calculated unit rates in real-time based on ongoing audience data and performance metrics of live advertising campaigns; and
updating ad placements based on the dynamically adjusted unit rates to improve campaign reach and publisher revenue.

20. The system of claim 14, wherein the optimizing comprises:
analyzing, by the computer system, the entire available TV ad inventory and all active advertising campaigns simultaneously to understand demand landscape across all campaigns;
dynamically relaxing or eliminating price floors for different segments of the available TV ad inventory based on real-time demand analysis and predictive analytics; and
maximizing total yield from the available TV ad inventory by making strategic decisions about which price floors to adjust and by how much, wherein the strategic decisions prioritize overall revenue generation across all campaigns rather than individual campaign optimization.
